(19) United States
(12) Patent Application Publication
(10) Pub. No.: US 2015/0161648 A1
(43) Pub. Date: Jun. 11, 2015

(54) SYSTEMS AND METHODS FOR CAPTURING, MANAGING, AND TRIGGERING USER JOURNEYS ASSOCIATED WITH TRACKABLE DIGITAL OBJECTS

(71) Applicants: Martin Charles Heath, Bramshott (GB); Paul Antony Inman, Orpington (GB); Zaid Christopher Haddadeen Crowe, Stafford (GB); Oliver Michael Phillip Huggins, Stirchley (GB)

(72) Inventors: Martin Charles Heath, Bramshott (GB); Paul Antony Inman, Orpington (GB); Zaid Christopher Haddadeen Crowe, Stafford (GB); Oliver Michael Phillip Huggins, Stirchley (GB)

(21) Appl. No.: 14/529,314

(22) Filed: Oct. 31, 2014

Related U.S. Application Data
(60) Provisional application No. 61/909,088, filed on Nov. 26, 2013.

(51) Int. Cl. G06Q 30/02; G06Q 50/00

(52) U.S. Cl. CPC G06Q 30/0236; G06Q 50/01

(57) ABSTRACT

System and methods for capturing, managing, and triggering user journeys is provided. The system is configured to enable participating individuals (e.g., a user) to generate and deliver trackable digital objects. The digital objects can be associated with enterprises, goods, services, etc. Each object can be traced by the system over a user journey, for example, as the digital object is referred through a user's social connections, to capture rich metadata. Each interaction with the digital object can be tracked by the system and the captured data attributed to the originating user, intermediate users, among other users and entities. The system provides accurate and clear measurement of influence on any one of the originating users and downstream users who interact with the digital object. In some implementations, the tracked data can be used to trigger additional processes based on action events associated with the digital object.

### RELATED APPLICATIONS

This application claims priority under 35 U.S.C. §119(e) to U.S. Provisional Application Ser. No. 61/909,088 entitled “SYSTEMS AND METHODS FOR CAPTURING, MANAGING, AND TRIGGERING USER JOURNEYS ASSOCIATED WITH TRACKABLE DIGITAL OBJECTS,” filed on Nov. 26, 2013, which is incorporated herein by reference in its entirety.

### BACKGROUND

Many conventional approaches exist for capturing information on user behavior. For example, on-line activity by users can be tracked by various respective sites and used to capture information on respective users. For example, cookies are known mechanisms that track user on-line activity and the cookies can be used to capture information on user behavior and/or preferences.

### SUMMARY

It is realized that conventional approaches can fail to develop information on users and their behavior across media channels. Conventional tracking systems can be limited to specific sites on which user information is collected. Accordingly, various aspects and embodiments of a distribution system are provided to overcome at least some of the failings of conventional approaches.

According to one aspect, various system and method embodiments are directed to empowering individuals to manage and take control of their data, harvesting their influence in social media and other platforms. According to one embodiment, it is appreciated that individuals can be more effective drivers of commercial activity through their own networks and personal influence for the benefit both of themselves and the enterprises that provide goods and/or services to them.

In one example, a system for capturing, managing, and triggering user journeys is provided. The system is configured to enable participating individuals (e.g., a user) to generate and deliver trackable digital objects. The digital objects can be associated with enterprises, goods, services, etc. Each object can be traced by the system over a user journey, for example, as the digital object is referred through a user's social connections, to capture rich metadata. Each interaction with the digital object can be tracked by the system and the captured data attributed to the originating user, intermediate users, among other users and entities. The system provides accurate and clear measurement of influence on any one of the originating users and downstream users who interact with the digital object. In some implementations, the tracked data can be used to trigger additional processes based on action events associated with the digital object. For example, the digital object may target awards based on a number of users registering for a site. Responsive to a threshold number of registrations (e.g., one example action) the originating user can be delivered an incentive.

According to another aspect, trackable digital objects are implemented in conjunction with a voting system. For example, viewers of audience participation television shows (e.g., American Idol or Britain's Got Talent) are asked to submit their votes for contestants in order for the contestants to advance in the competition. Many such shows exist where audience participation can affect outcomes for the participants. It is realized that audience participation in such settings is dwindling. Conventional “phone-in” voting is perceived as old fashioned, and further discouraged by associated charges.

Accordingly, provided are embodiments that deliver the opportunity for audience members to fully engage their contacts and combine television entertainment with social media activity that is trackable. According to one example, a participant can register their “social vote” by signing up to a fan distribution campaign. The participant can share the campaign into their social networks. The act of sharing the campaign creates a trackable digital object unique to that participant that is injected into the participant's social network. As the participant's friends, connections, family, etc., interact with the trackable digital object, the activity is traceable to the participant and the participant's influence over their network can be measured and rewarded even across multiple social media channels or other distribution channels. In the social voting context, the participant can be rewarded based on the number of votes the participant collects across their social network channels, for example, as the participant's friends engage in social voting.

According to one embodiment, the system provides a user-controlled, opt-in toolset for allowing users to share with other users. The user controlled toolset can be configured to provide any one or more of the following features: user-directed peer-to-peer communication across all media communication platforms (e.g., social networking sites, blogs, user communities, e-mail, chat groups, encapsulating any communication platform that includes a web presence); measurement of individual influence across the media platforms; creation of incentives and rewards to promote peer-to-peer activity; creation, management, direction, and measurement of peer-to-peer marketing campaigns; creation and maintenance of individual secure personal data stores for securing the data generated from this activity. Further, users may be permitted to selectively communicate certain information to other users across selected communication channels (e.g., selectively among different communication platforms), and track user interactions among those channels. Tools may be provided to access the performance of particular communication channels with regard to the user communications. Tools may be provided for users to be able to rate each communication channel's effectiveness. In one example, the system is configured to define a standardized scale for user selection. Based on user selections of channel effectiveness, the can combine responses into scores for respective communication channels. The scores can be used rank respective communication channels.

According to another aspect, the system can also include enterprise solutions that enable businesses to engage in peer-to-peer marketing at scale by integrating, for example, the opt-in user tools, and the output data from the use, sharing, and execution of actions (e.g., including any output generated from user interaction) associated with digital objects. According to one embodiment, the combination of user side generation tools and enterprise analytics with fully attributed influence data allows users and enterprises to work collaboratively to profit both users and the enterprise. In one example, a commercial enterprise works with their most engaged, influential customers through the system to drive increased sales, acquire new customers, improve marketing efficiency, and capture information on new product market testing, among other options. Through those interactions, the enterprise builds greater understanding of their most influential customers yielding greater insight and increasing the enterprise's capability to reward such customers and improve the enterprises operating margins by optimizing the enterprises process through integration of Customer Experience Management (CXM) tools and data.

According to another aspect, putting the power of mass-adopted technology into the hands of individuals enables the individual to manage their own benefits. The individual can actively control financial benefits achieved based on, for example, driving new activity to an enterprise through their influence and insights. Commercial enterprises value such direct relationships with their customers above anything else. In some embodiments, the system facilitates a cyclic relationship of mutual value creation. Influencers drive new revenue to the enterprise and the enterprise responds with direct financial and other benefits to the influencers.

According to one aspect, a system for distributing content among a plurality of users is provided. The system comprises a computer-based interface for designing, by at least one of the plurality of users, an object to be shared with other users, a component that is configured to create a uniquely addressable web presence associated with the object, a distribution component configured to share the object with the other users among a plurality of selectable communication channels, a tracking component configured to track interactions with the shared object by the other users, and an attribution component configured to attribute the tracked interactions to the at least one of the plurality of users.

According to one embodiment, the distribution component is configured to share a reference to the object with the other users. According to one embodiment, the tracking component is adapted to track interactions of the other users with a website associated with the uniquely addressable web presence associated with the object. According to one embodiment, the selectable communication channels include at least one of a group comprising: a messaging application, a social networking application, an email application, and a website.

According to one embodiment, the system further comprises a component that tracks shared objects created by the at least one of the plurality of users. According to one embodiment, the attribution component is configured to track interactions with the shared objects created by the at least one of the plurality of users and attribute the interactions with the at least one of the plurality of users. According to one embodiment, the system further comprises a component that measures a marketing effectiveness of the at least one of the plurality of users responsive to the attribution component. According to one embodiment, the system further comprises an award-determining component configured to determine an award responsive to an attribution determination performed by the attribution component. According to one embodiment, the system further comprises a component that measures a marketing effectiveness of the at least one of the plurality of users within the plurality of selectable communication channels responsive to the attribution component.

According to one aspect, a system for distributing content among a plurality of users is provided. The system comprises a computer-based interface for designing, by at least one of the plurality of users, an object to be shared with other users, a distribution component configured to share the object with the other users among a plurality of selectable communication channels, a tracking component configured to track interactions with the shared object by the other users, an attribution component configured to attribute the tracked interactions to the at least one of the plurality of users, an award-determining component configured to determine an award responsive to an attribution determination performed by the attribution component.

According to one embodiment, system further comprising a component configured to create a uniquely addressable web presence associated with the object to be shared with the other users. According to one embodiment, the computer-based interface for designing, by the at least one of the plurality of users, the object to be shared with other users further comprises a plurality of templates that may be chosen by the at least one of the plurality of users for creating the object. According to one embodiment, at least one of the plurality of templates comprises: an area for inserting, by the least one of the plurality of users, one or more media objects, and an action element that permits a receiving user to perform a desired action with the object.

According to one embodiment, the action element, when selected by the receiving user, initiates a desired action within one or more communication channels. According to one embodiment, the action element, when selected by the receiving user, causes the tracking component to track the desired action with the object. According to one embodiment, the desired action includes at least one of a group comprising a view of the shared object, a sharing of the shared object with at least one other user, a transaction relating to the object and an online action relating to the shared object.

According to another aspect, a computer implemented method for distributing content among a plurality of users is provided. The method comprises receiving, by a computer system, an object design entered in a user interface by a user, generating, by the computer system, a uniquely addressable web presence associated with the object, distributing, by the computer system, the object with other users within a plurality of selectable communication channels, tracking, by the computer system interactions with the shared object by the other users, and attributing, by the computer system, the tracked interactions to the user.

According to some embodiments, the method further comprises an act of distributing, by the computer system, a reference to the uniquely addressable web presence with the other users; the method further comprises an act of embedding, by the computer system, a unique reference attributable to the user within the object; the tracking component is adapted to track interactions of the other users with either or both of a reference associated with the user or a website associated with the uniquely addressable web presence associated with the object; the act of distributing the object is responsive to receiving a selection of one, two, three, four, or more of the plurality of selectable communication channels, wherein the selections is made from a group comprising: a messaging application; a social networking application; an email application; and a website; the method further comprises tracking by the computer system, the object responsive to at least one of the plurality of users sharing the object within the plurality of selectable communication channels; the method further comprises tracking interactions with shared objects created by the at least one of the plurality of users from the object and attribute interactions with the shared objects to either or both of the user and the at least one of the plurality of users; the method further comprises measuring, by the computer system, a marketing effectiveness of the at least one of the plurality of users responsive to tracking interactions; the method further comprises determining component configured to determine an award responsive to an attribution determination performed by the attribution component; and the method further comprises a component that measures a marketing effectiveness of the at least one of the plurality of users within the plurality of selectable communication channels responsive to the attribution component.

According to one aspect, a system for distributing content among a plurality of users is provided. The system comprises a distribution component configured to share an object created by at least one of the plurality of users with other users among a plurality of selectable communication channels, receiving, by a plurality of recipient users, the shared object, identifying unique recipient users of the shared object, and collecting information regarding the unique recipient users of the received object, wherein the information includes at least one of a group of information comprising information regarding the unique recipient users and behavior of the unique recipient users with respect to the received object.

According to one embodiment, the system further comprises a component that permits at least one of the unique recipient users to elect to provide the information. According to one embodiment, the information regarding the behavior of the unique recipient users includes at least one of a group of behaviors comprising: a view of the shared object, a sharing of the shared object with further recipient users, a transaction relating to the shared object, an online action relating to the shared object, and an offline action relating to the shared object.

According to one aspect, a system for distributing content among a plurality of users is provided. The system comprises a computer-based interface for designing, by at least one of the plurality of users, an object to be shared with other users, a distribution component configured to share the object with the other users among a plurality of selectable communication channels, wherein the selectable communication channels include at least one of a group comprising, a messaging application, a social networking application, an email application, and a website, a tracking component configured to track interactions with the shared object by the other users that receive the object via at least one of the selectable communication channels, and an attribution component configured to attribute the tracked interactions to the at least one of the selectable communication channels.

According to one aspect, a system for distributing content among a plurality of users is provided. The system comprises a computer-based interface for designing, by at least one of the plurality of users, an object to be shared with other users, the object including a unique identifier that associates behavior and actions relating to the object to the at least one of the plurality of users, a distribution component configured to share the object with the other users among a plurality of selectable communication channels, a tracking component configured to track interactions with the shared object by the other users within the plurality of selectable communication channels, and an attribution component configured to attribute the tracked interactions to the at least one of the plurality of users.

According to one aspect, a system for distributing content among a plurality of users is provided. The system comprises a computer-based interface for designing, by at least one of the plurality of users, an object to be shared with other users, a distribution component configured to share the object with the other users among a plurality of selectable communication channels, a tracking component configured to track interactions with the shared object by the other users, an attribution component configured to attribute the tracked interactions to the at least one of the plurality of users, and a value-determining component configured to determine an value of the at least one of the plurality of users responsive to an attribution determination performed by the attribution component.

According to one aspect, a system for distributing content among a plurality of users is provided. The system comprises a computer-based interface for sharing, by at least one of the plurality of users, an object with other users through a plurality of platforms, a component configured to identify the shared object uniquely among the plurality of platforms, and a tracking component configured to track interactions with the shared object by the other users based on the unique identification of the shared object.

According to another embodiment, a system for managing fan distribution campaigns is provided. The system comprises at least one processor operatively connected to a memory, the at least one processor when running is configured to execute a plurality of system components, a user interface component configured to receive an object design input by at least one of a plurality of users, a generation component configured to create an object to be shared with other users, the object including a unique identifier that associates behavior and actions relating to the object to the at least one of the plurality of users, a distribution component configured to distribute the object with the other users among a plurality of selectable communication channels, a tracking component configured to track interactions with the object by the other users within the plurality of selectable communication channels, and an attribution component configured to attribute the tracked interactions to the at least one of the plurality of users.

According to some embodiments, the system further comprises a role component configured to identify an administrator of a master campaign; the user interface component is further configured to accept user registration to participate in a fan distribution campaign; the user interface component is further configured to accept user definition of a campaign master; the system is further configured to generate either one or both of a web presence or a master object to manage the master campaign; the system is further configured to accept user registration through the either one or both of the web presence or the object from the at least one of a plurality of users; the system is further configured to require the at least one of a plurality of users to register in order to create the object; the campaign master includes at least one of content selection, participation requirements, goals, or rewards; the user interface component is configured to receive the object design input based on user selection of content defined by the campaign master; the campaign master defines a plurality of content selections for user endorsement and distribution; the content selections for user endorsement and distribution include a plurality of contestants participating in a competition; the campaign master further comprises a plurality of templates that may be chosen by the at least one of the plurality of users for creating the object; at least one of the plurality of templates comprises an action element that permits a receiving user to perform a desired action with the object, and wherein the action element is configured to communicate a vote for at least one of the plurality of contestants participating in the competition; and the system is further configured to create a uniquely addressable web presence associated with the object to be shared with the other users; the component is further configured to embed a unique reference attributable to the at least one of the plurality of users within the object.

According to another aspect, a computer implemented method for managing fan distribution campaigns is provided. The method comprises receiving, by a computer system, an object design input by at least one of a plurality of users in a user interface, creating, by the computer system, an object to be shared with other users, the object including a unique identifier that associates behavior and actions relating to the object to the at least one of the plurality of users, distributing, by the computer system, the object to the other users via at least one of a plurality of selectable communication channels, tracking, by the computer system, interactions with the object by the other users within the plurality of selectable communication channels; and attributing, by the computer system, the tracked interactions to the at least one of the plurality of users.

In some embodiments, the method further comprises identifying, by the computer system, an administrator of a master campaign; the method further comprises receiving user registration information entered into the user interface to participate in a fan distribution campaign; the method further comprises receiving from the user interface user input defining a campaign master; the method further comprises generating, by the computer system, either one or both of a web presence or a master object to manage the master campaign; the method further comprises receiving user registration information through the either one or both of the web presence or the object from the at least one of a plurality of users; the method further comprises an act of requiring, by the computer system, the at least one of a plurality of users to register in order to create the object; defining the campaign master includes defining at least one of content selection, participation requirements, goals, or rewards; the method further comprises an act of receiving the object design input based on user selection of content defined by the campaign master; defining the campaign master includes defining at a plurality of content selections for user endorsement and distribution; the content selections for user endorsement and distribution include a plurality of contestants participating in a competition; defining the campaign master includes defining a plurality of templates that may be chosen by the at least one of the plurality of users for creating the object; at least one of the plurality of templates comprises an action element that permits a receiving user to perform a desired action with the object, and the method further comprises receiving, by the computer system, responsive to selection of the object or the action item a vote for at least one of the plurality of contestants participating in the competition; creating, by the computer system, the object includes an act of creating a uniquely addressable web presence associated with the object to be shared with the other users; creating, by the computer system, the object includes an act of embedding a unique reference attributable to the at least one of the plurality of users within the object.

According to another aspect, a system for awarding user activity among a plurality of users is provided. The system comprises at least one processor operatively connected to a memory, the at least one processor when running is configured to execute a plurality of system components, a distribution component configured to share a digital object with a plurality of users responsive to selection of at least one of a plurality of selectable communication channels, wherein the digital object includes attribution information for an originating user, a tracking component configured to track interactions with the digital object by the plurality of users, an attribution component configured to attribute the tracked interactions to a campaign created by the originating user, and an award-determining component configured to determine an award responsive to an attribution determination performed by the attribution component.

According to some embodiments, the system further comprises a valuation component configured to establish a value associated with the originating user's influence over the plurality of users; the valuation component is further configured to determine a value associated with the originating user's influence with respective ones of the plurality of selectable communication channels; the system further comprises a user interface component configured to present user interfaces for designing a campaign; the system is configured to accept registration information from the plurality of users, and wherein the distribution component is further configured to distribute the digital object including attribution information for respective ones of the plurality of users, responsive to accepting respective registration information; the user interface component is further configured to present user interfaces for defining award criteria associated with the campaign; the user interface component is further configured to present user interfaces for defining one or more actions associated with the digital object to be tracked or attributed; the tracking component is configured to receive information on the one or more user actions responsive to user selection of an action element in the digital object; the system further comprises a generation component configured to create a uniquely addressable web presence associated with the digital object; the tracking component is configured to receive information on the one or more user actions responsive to user selection of an action element associated with the uniquely addressable web presence; the award-determining component is further configured to determine an award responsive to a plurality of user defined awards defined by the originating user; the award-determining component is further configured to determine completion of any one or more of the plurality of the user defined awards responsive to comparing the tracked interactions attributed to a respective one of the plurality of users to a threshold associated with one or more desired user actions; the desired action includes at least one of a group comprising a view of the digital object, a sharing of the digital object with at least one other user, a transaction relating to the digital object, a view of a uniquely addressable web presence associated with the digital object, an action taken within a uniquely addressable web presence associated with the digital object, a transaction, an online action relating to the digital object, and an offline action associated with the digital object; and the tracking component is further configured to receive information on receipt by a plurality of recipient users of the digital object; identify unique recipient users of the digital object; and collect information regarding the unique recipient users of the received object.

According to another aspect, a computer implemented method for awarding user activity among a plurality of users is provided. The method comprises distributing, by a computer system, a digital object to a plurality of users responsive to selection of at least one of a plurality of selectable communication channels, wherein the digital object includes attribution information for an originating user, tracking, by the computer system, interactions with the digital object by the plurality of users, attributing, by the computer system, the tracked interactions to a campaign created by an originating user, and determining, by the computer system, an award responsive to the act of attributing performed by the computer system.

According to some embodiments, the method further comprises a user interface component configured to present user interfaces for designing a campaign; the method further comprises receiving, by the computer system, registration information from the plurality of users, and wherein the act of distributing the digital object includes distributing the digital object with attribution information for respective ones of the plurality of users, responsive to receiving respective registration information; the method further comprises displaying user interfaces for defining award criteria associated with the campaign; the method further comprises displaying user interfaces for defining one or more actions associated with the digital object to be tracked or attributed; the act of tracking includes receiving information on the one or more user actions responsive to user selection of an action element in the digital object; the method further comprises generating, by the computer system. a uniquely addressable web presence associated with the digital object; the act of tracking includes receiving information on the one or more user actions responsive to user selection of an action element associated with the uniquely addressable web presence; the act of determining the award includes determining an award responsive to a plurality of a user defined awards; the act of determining the award includes determining completion of any one or more of the plurality of the user defined awards responsive to comparing the tracked interactions attributed to a respective one of the plurality of users to a threshold associated with one or more desired user actions; the desired action includes at least one of a group comprising a view of the digital object, a sharing of the digital object with at least one other user, a transaction relating to the digital object, a view of a uniquely addressable web presence associated with the digital object, an action taken within a uniquely addressable web presence associated with the digital object, a transaction, an online action relating to the digital object, and an offline action associated with the digital object; wherein the method further comprises receiving information on receipt by a plurality of recipient users of the digital object, identifying unique recipient users of the digital object, and collecting information regarding the unique recipient users of the received object.

According to another aspect, a system for capturing behavioral data from a plurality of users is provided. The system comprises at least one processor operatively connected to a memory, the at least one processor when running is configured to execute a plurality of system components, a distribution component configured to share a digital object with a plurality of users responsive to selection of at least one of a plurality of selectable communication channels, wherein the digital object includes attribution information for an originating user, a tracking component configured to track interactions with the digital object by the plurality of users, wherein the tracking component is further configured to collect information regarding unique recipient users of the shared digital object, wherein the information includes at least one of a group of information comprising information regarding the recipient users, behavior of the unique recipient users with respect to the received object, and behavior of the unique recipient users with respect to online sites, and an attribution component configured to attribute the tracked interactions to at least one of the originating user and respective unique recipient users of the digital object from the plurality of users.

According to some embodiments, the attribution component is further configured to identify unique users based on a digital fingerprint associated with the tracked interactions; the system further comprises an identification component configured to generate a digital fingerprint associated with a respective user; the identification component is configured to generate the digital fingerprint responsive to receiving any one or more within a group comprising: user device identifier, IP address, browser, browser plug-ins, browser version, position information, current sign-ons, active log-ins, and user computer or device specific information; the system is further configured to store one or more digital fingerprints associated with registered users; the identification component is configured to select the digital finger print from previous tracked information based on received information and determine a match based on a comparison of fingerprints; the tracking component is configured to receive information from online sites external to the system; the tracking component is configured to generate tracking module for installation on online sites in conjunction with generating digital objects; the tracking module is configured to communicate tracking information from the online site to the system; the information regarding the behavior of the unique recipient users and behavior of the unique recipient users with respect to online sites includes at least one of a group of behaviors comprising: a view of the shared object; a sharing of the shared object with further recipient users; a transaction relating to the shared object; an online action taken on a website external to the system; and an offline action relating to the shared object; the system is further configured to accept registration information from the plurality of users and stored a digital fingerprint or information for generating a digital fingerprint as part of a registered user profile; the tracking component is configured to receive information on one or more user actions responsive to user selection of an action element in the digital object; the system further comprises a generation component configured to create a uniquely addressable web presence associated with the digital object hosted by the system; and the tracking component is configured to receive information on one or more user actions responsive to user selection of an action element associated with the uniquely addressable web presence.

According to another aspect, a computer implemented method for capturing behavioral data from a plurality of users is provided. The method comprises distributing, by a computer system, a digital object with a plurality of users responsive to selection of at least one of a plurality of selectable communication channels, wherein the digital object includes attribution information for an originating user, tracking, by the computer system, interactions with the digital object by the plurality of users, wherein tracking includes collecting information regarding unique recipient users of the shared digital object, wherein the information includes at least one of a group of information comprising information regarding the recipient users, behavior of the unique recipient users with respect to the received object, and behavior of the unique recipient users with respect to online sites, and attributing, by the computer system, the tracked interactions to at least one of the originating user and respective unique recipient users of the digital object from the plurality of users.

According to some embodiments, attributing the tracked interactions includes identifying unique users based on a digital fingerprint associated with the tracked interactions; the method further comprises generating a digital fingerprint associated with a respective user; generating the digital fingerprint associated with a respective user occurs in response to receiving any one or more within a group comprising: user device identifier, IP address, browser, browser plug-ins, browser version, position information, current sign-ons, active log-ins, and user computer or device specific information; the method further comprises storing one or more digital fingerprints associated with each registered user; the method further comprises selecting the digital finger print from previous tracked information based on received information; and determining a match based on a comparison of fingerprints; tracking by the computer system, interactions includes receiving information from external online sites; the method further comprises generating a tracking module for installation on external online sites; the method further comprises receiving from the tracking module the tracking information from the external online site; the information regarding the behavior of the unique recipient users and behavior of the unique recipient users with respect to online sites includes at least one of a group of behaviors comprising: a view of the shared object; a sharing of the shared object with further recipient users; a transaction relating to the shared object; an online action taken on a website external to the method; and an offline action relating to the shared object; the method further comprises storing registration information from the plurality of users and storing a digital fingerprint or information for generating a digital fingerprint as part of a registered user profile; tracking by the computer system, interactions includes receiving information on one or more user actions responsive to user selection of an action element in the digital object; the method further comprises creating a uniquely addressable web presence associated with the digital object; and tracking by the computer system, interactions includes receiving information on one or more user actions responsive to user selection of an action element associated with the uniquely addressable web presence.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by reference signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a block diagram of a conventional system for user engagement;

FIG. 2 is a block diagram of an example use case of the system according to one embodiment;

FIG. 3 is an example process shows an example process for distributing digital objects, according to one embodiment;

FIG. 4 is an example process flow for creating and communicating objects, according to one embodiment;

FIG. 5 illustrates example use cases for a system that allows sharing of objects according to one embodiment;

FIG. 6 illustrates example functionality provided by a person-to-person engagement system, according to one embodiment;

FIG. 7A is a block diagram of an example system for communicating with one or more other users, according to one embodiment;

FIG. 7B is a block diagram of an example system for managing trackable digital objects, according to one embodiment;

FIG. 8A-B is a block diagram of an example system for accessing tools for creating and communicating campaigns in an insurance setting, according to one embodiment;

FIG. 9 is a block diagram of a general purpose computer system on which various aspects of the disclosure can be practiced;

FIG. 10 is a block diagram of a memory system on which various aspects of the disclosure can be practiced;

FIG. 11 is an example user interface and campaign creation display, according to one embodiment;

FIG. 12 is an example user interface for specifying appearance attributes of a generated campaign, according to one embodiment;

FIG. 13 is an example user interface for creating a campaign, according to one embodiment;

FIG. 14 is an example user interface for managing user created campaigns, according to one embodiment;

FIG. 15 is an example screen capture of an example campaign domain, according to one embodiment;

FIG. 16 is an example screen capture of an overlay display, according to one embodiment;

FIG. 17 is an example user interface including unique identifying information for a campaign, according to one embodiment;

FIG. 18 is an example user interface including unique identifying information for a campaign, according to one embodiment;

FIG. 19 is an example user interface including unique identifying information for a campaign, according to one embodiment;

FIG. 20 is an example user interface including unique identifying information for a campaign, according to one embodiment;

FIG. 21 is an example user interface including unique identifying information for a campaign, according to one embodiment;

FIG. 22 is an example user interface for showing a dashboard display, according to one embodiment;

FIG. 23 is an example user interface for creating goals associated with a campaign, according to one embodiment;

FIG. 24 is an example user interface for displaying graphical reporting information, according to one embodiment;

FIG. 25 is an example user interface for creating new goals, according to one embodiment;

FIG. 26 is an example use case for a social voting context, according to one embodiment;

FIG. 27 is an example process for capturing information from trackable digital objects, according to one embodiment; and

FIG. 28 is an example process for creating and distributing a fan distribution campaign, according to one embodiment.

### DETAILED DESCRIPTION

Stated broadly various aspects are directed to enabling individual customers to become micro-affiliates and/or advocates of commercial entities promoting products, services, and/or actions favorable to the commercial entities through trackable digital objects. The system captures all aspects of the user journeys that originate with such micro-affiliates, for example through interaction with the digital object, the enterprises web-site, and even off-line. Capture of the entire user journey allows harvesting of accurate influence information. In exchange, the influential customers can receive a fair exchange of value derived from their activity as mini-affiliates and even manage their own compensation for the mutual benefit of the enterprise and consumers. In some embodiments, the enterprise users can directly manage offers and/or compensation to participating users. In further embodiments, users would be able to set their rewards, for example, by advertising that they were willing to work to promote enterprises. In some examples, the system can provide an influencer jobs bulletin board for posting such advertisements and/or establishing availability of opt in users.

At least some embodiments disclosed herein include apparatus and processes for creating, tracking, referring, and/or incentivizing delivery of digital objects through peer to peer functions and/or opt-in tool sets, and may also include apparatus and processes for analyzing and/or valuing data generated from those digital objects, actions associated with the objects, etc. Further, some embodiments utilize the digital objects and incentives to foster a symbiotic relationship between goods and service providers and the consumers who desire the goods or services, where both consumers and commercial enterprises receive actionable benefit (e.g., in the form of information on influencers and/or effect of respective influence). In some examples, objects may be embedded in a blog, tumblr, facebook page, email, or a tweet by users, and all data & activities around each embedded object are captured by the system, and can be displayed in a user dashboard to show a measure of interest (clicks), adoption (transactions) and virality (shares) to report demand/influence across different markets sectors products and services.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

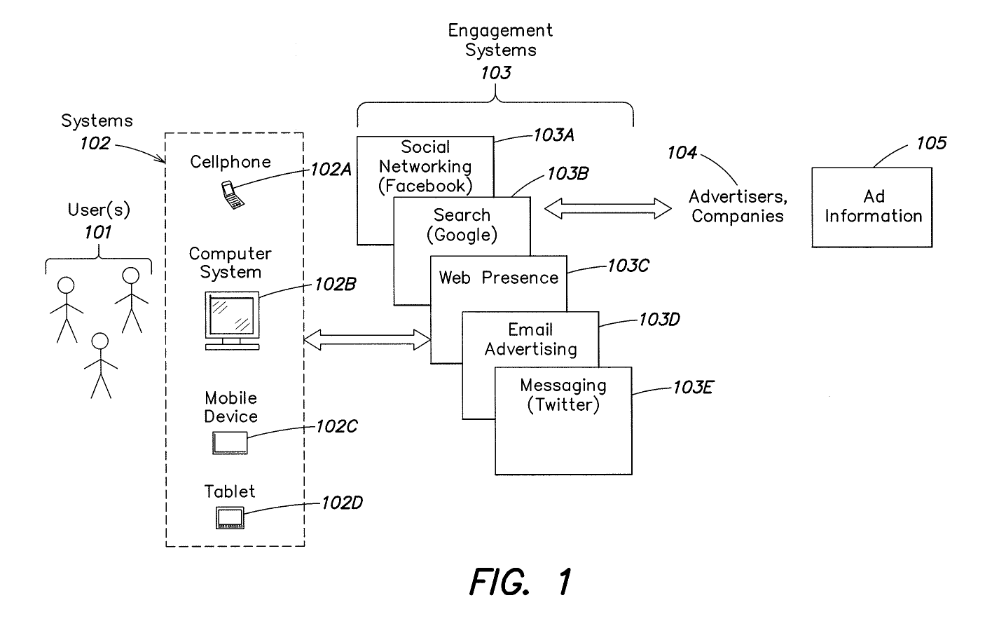

In conventional systems, users typically engage with information that is provided to them by a number of information providers. For instance, shown in FIG. 1, one or more users 101 use a number of electronic systems 102 to interact with one or more engagement systems 103 for the purpose and sharing information. For instance, users 101 may operate one or more systems 102 such as a cell phone 102A, computer system 102B, mobile device 102C, tablet 102D, among other devices.

Such users may engage with engagement systems 103 to communicate information to other users. Such engagement systems may include, for example, social networking systems (e.g., element 103A (e.g., FACEBOOK)), one or more search engines (e.g., element 103B (e.g., Google), one or more Internet sites or other type of web presence (e.g., element 103C (e.g., websites, apps, distributed applications, etc.)), email advertising (e.g., element 103D), and/or messaging platforms (e.g., element 103E (e.g., Twitter, SMS, etc.)). Such systems are common in that information is directed to users from various entities such as advertisers, companies, or other organizations (e.g., element 104). Such information typically includes ad information 105 or other information type that needs to be communicated by the entity.

According to one aspect of the present invention, it is appreciated that direct person-to-person communication and a rich set of tools may be provided that allow users to more effectively communicate with one another. It is appreciated that such forms of person-to-person communication may be more effective than the traditional model of user engagement where entities determine what message should be provided on behalf of the entity. Rather, according to various embodiments, direct person-to-person communication tools that provide social network integration, are independent of preferred communication channels, provide tracking and attribution for individual users, among other features, and allow the user to more effectively relay messages to their constituents.

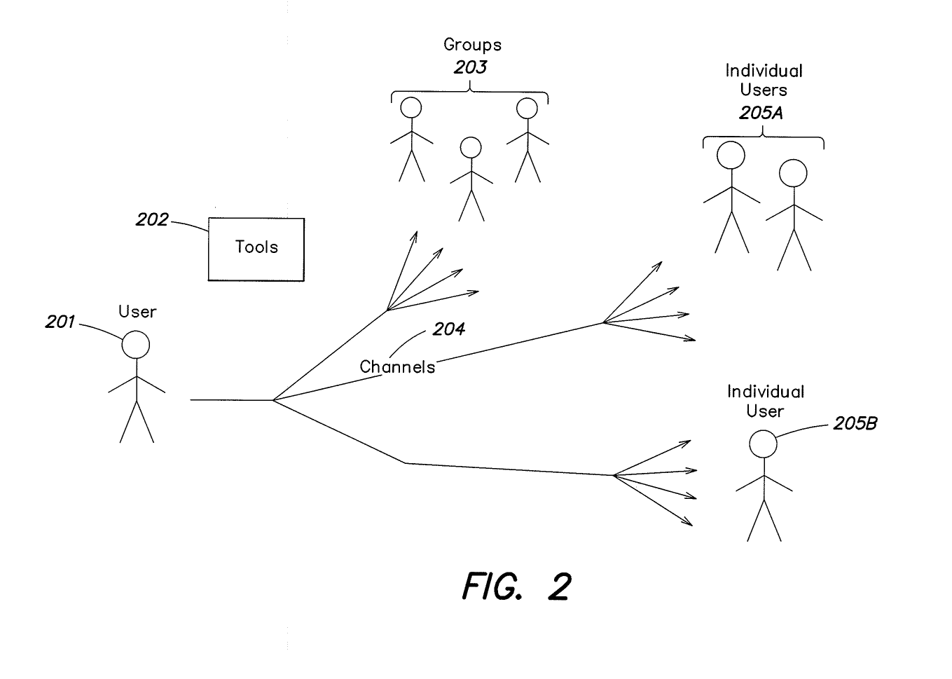

FIG. 2 shows an example use case of the system according to one embodiment of the present invention. In particular, a user 201 is provided a set of tools 202 that permit the user to communicate messages through one or more communication channels 204. For instance, such channels may include conventional channels such as social networking, web presence, email, messaging and other types of communication channels that link users together. Such tools may permit the user 201 to define one or more information objects that may be shared with other users. Such information may be disseminated to individual users (e.g., users 205A, 205B) and groups of users (e.g., groups 203) using the tools 202.

In one embodiment, the tools provide the ability for user to create, in an easy manner, information that may be shared with other users. In one embodiment, an information object may be defined that references an Internet object with which one or more users may interact. During various points of interesting user interaction, information may be tracked associated with that particular object.

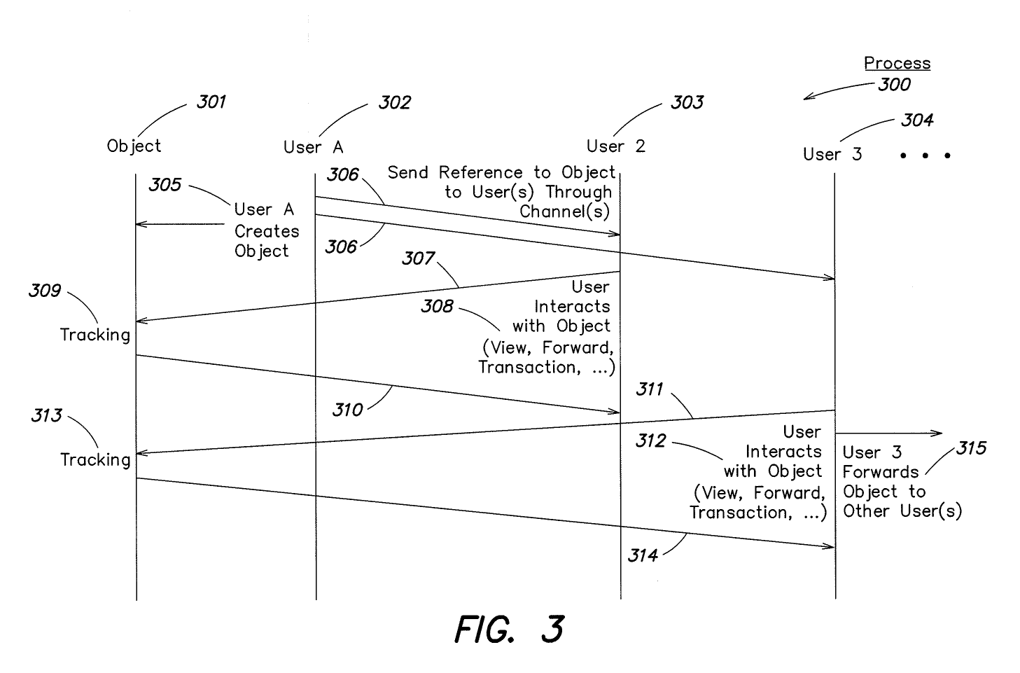

FIG. 3 shows an example process 300 according to one embodiment of the present invention. In particular, as shown in FIG. 3, the user A 302 creates an object 301 at element 305. User A 302, using a computer system, selects one or more channels to communicate the created object with one or more users. User A 302 may, for example, implement one or more user tools to create an object, select one or more communication channels, and select one or more users to whom the message will be communicated. For instance, the tools may be integrated within end-user applications such as FACEBOOK, TWITTER, email programs, among others. According to one embodiment, an end system associated with the user may be configured to send a reference to the object to one or more users through one or more channels as described above (e.g., at element 306). In one embodiment, the user may be able to specify which user or user group may be contacted within a particular channel.

According to one embodiment, a number of users (e.g., user 2 (303), user 3 (304)) may receive the reference to the object from user A, and may interact with the object in a number of different ways. For instance, the user may view the object, forward the object to other users, may perform a transaction associated with the object, among other user actions. In one example, the originating user may indicate which transactions are interesting and/or valuable for the particular user. For instance, user 2 (303) may perform a transaction (e.g., action 307) with the object 301, and a tracking operation 309 may be performed.

For instance, tracking operations may be performed using a tracking component installed on a website page associated with the object. In one implementation, the object may be associated with a website link, and a reference to the link may be distributed among a number of different channels. The website may be created using the user tools as the user creates objects associated with the identity of that user. As users interact with the object, tracking data, environmental data, and information about the user is collected.

The system may provide a response (e.g., element 310) to the user that relates to the interaction, such as a verification of the transaction, a view of a page associated with the object, a forwarding action within an application or other response may be provided. Similarly, another user (e.g., user 3 (304)) may receive a reference to the object, interact with that object, have some tracking operations performed, and may receive one or more appropriate responses (e.g., at elements 311-314). Additionally, a user may forward an object to other users, after which other users may interact with the object.

Other systems (e.g., transaction systems, offline systems, etc.) may be provided that include one or more components that are configured to track other types of user interactions. In this manner, user's online and offline behavior may be tracked and attributed to an originator of the particular object. To this end, the object may be associated uniquely with the originating user (e.g., by creating a unique website presence associated with the object which is associated with that user). Tools may be provided that allow the user or other party (e.g., an employer, a retailer, advertiser or other entity) to track the performance of a particular user. Similarly, tools may be provided that allow performance of other elements along the chain of communication to be tracked. For instance, the object's performance may be evaluated (e.g., as compared to other objects), certain channels may be evaluated for effectiveness (e.g., GOOGLE+ versus FACEBOOK), or other comparison may be made for the purpose of evaluating and improving the communication and effectiveness of the message.

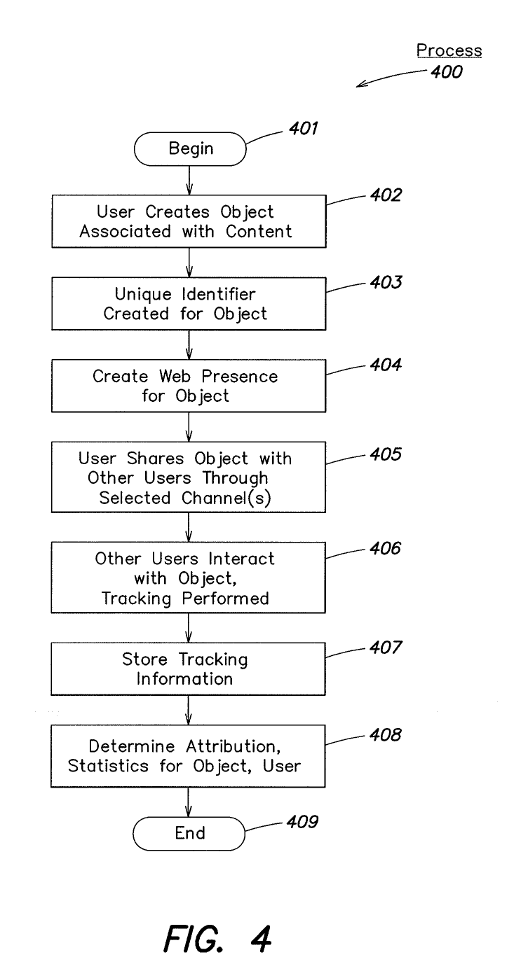

FIG. 4 shows a process 400 for creating and communicating objects within a user to user system at block 401, process 400 begins. At block 402, a user creates an object associated with some content. For instance, the user may want to share an advertisement, message, media file or some other content with one or more users. At block 403, a unique identifier is created for the object. Further, the system may create a unique web presence for the object at block 404. This may include, for example, providing a unique link that may be shared among users.

At block 405, the user shares the object with other users through one or more selected channels. For instance, the user may select one or more communication methods and/or platforms for communicating the message, including but not limited to GOOGLE+, FACEBOOK, email programs, TWITTER, LinkedIn, among others. At block 406, other users interact with the object and tracking operations are performed. At block 407, the system stores tracking information and at block 408 the system determines attribution, statistics for the object, and any statistics associated with that particular user. At block 409, process 400 ends.

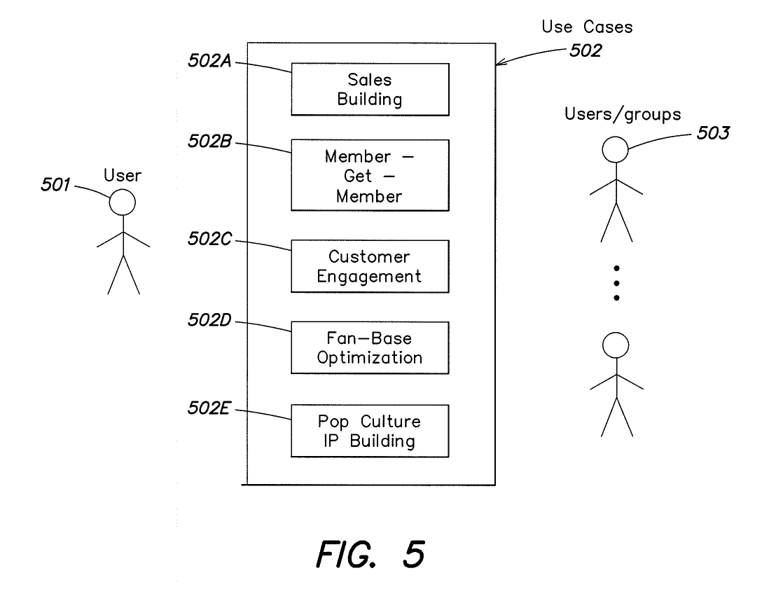

FIG. 5 shows some example use cases for a system that allows sharing of objects according to various embodiments of the present invention. For instance, a user 501 may have many reasons to engage other users or groups of users (e.g., users/groups 503). For example use cases 502 may include a sales building scenario (502A) where users are sales agents (either independent or part of an organization) that are looking to engage users for the purpose of selling products or services. In such a scenario, it may be beneficial to have such a system so that users (e.g., salespersons) can more directly engage customers to increase the likelihood that sales occur. Also, a tracking capability that tracks the marketing efforts of particular salespeople may allow the system to evaluate effectiveness of each salesperson.

In another use case, members of a particular organization, group, or other affiliation communicate with other users to recruit other members (e.g., in a member-get-member use case 502B). Here, communication tools may be beneficial to allow particular users to reach out through their networks for the purpose of recruiting new users. Such recruiting actions may be more effective, as other members are more likely to sign up if they know the member that is performing the recruiting action.

In another use case, agents of an organization use such tools to communicate and otherwise engage customers (e.g., in a customer engagement use case 502C). Because such tools may permit users to reach other users easily to enter a number of different channels, such methods may allow more frequent communications by many different types of users. Further according to one embodiment, such tools may be easily used by unsophisticated users, and therefore may be used as a company tool for agents of an organization to communicate with customers on a regular basis. In yet another use case, such tools may be used by agents of an organization to communicate and motivate context associated with that organization (e.g., in a fan-base optimization use case 502D). In still another use case, such tools may be used to create and build IP in the entertainment sector in television, music, talent, publishing, and pop culture (e.g., in a pop culture IP building use case 502E) where information regarding media may be developed and shared with users with virality encouraged through use of incentives for sharing and the outcomes of sharing (e.g. generating clicks on a YT channel). Many other use cases in a number of different markets may be used for the purpose of engaging users in a person-to-person environment. For instance, such tools may be used in e-commerce for engaging customers, the insurance industry, media and entertainment, among others that would benefit from person-to-person marketing and engagement.

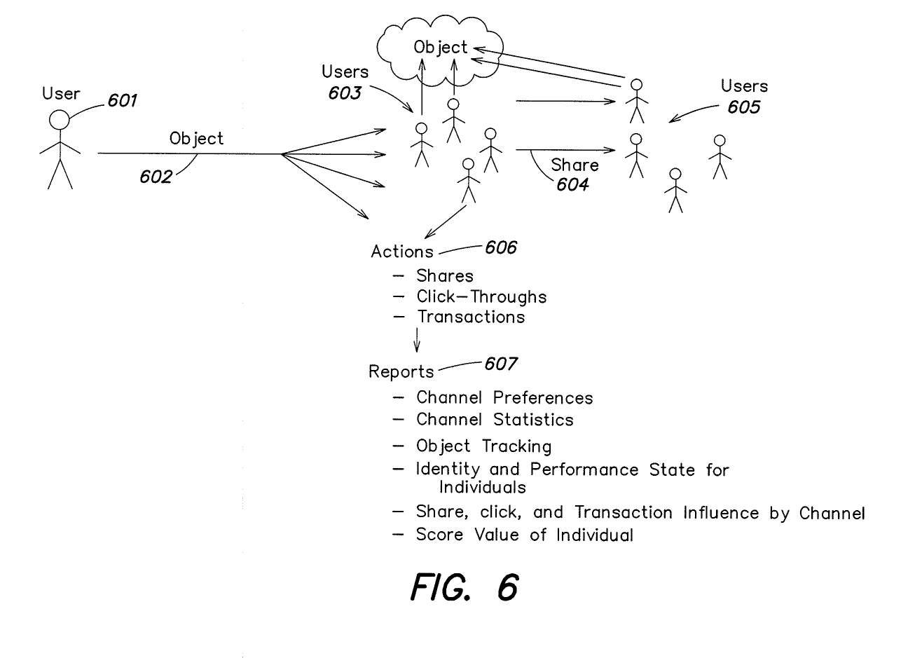

FIG. 6 shows example functionality that may be provided by a person-to-person engagement system according to various embodiments of the present invention. For instance, the user 601 may create and communicate an object 602 that may be provided initially to a number of users 603. Users can take a number of different actions 606 associated with the object, such as viewing, sharing, performing click throughs, transactions, among other options.

Further, the system may provide different information for the user and other organizations regarding the interaction of users with the created object. For instance, reports 607 may be generated that indicate information regarding the channel, performance of users associated with the object, performance of particular individuals and their networks, among other information may be determined. For instance, preferences for particular channel, channel statistics, tracking of objects and accesses, identity and performance state for users and the individual users that access the objects may be monitored and reported. Further, share, click, and transaction influence may be computed and displayed for the particular individual or channel used to communicate the information. Further, according to another embodiment, a score may be determined for that particular individual to evaluate the value of that person's network and/or effectiveness as a communicator. In one example, the individual user's value may be computed based on a monetary measure of the transactions that were ultimately performed as a result of the user's communication.

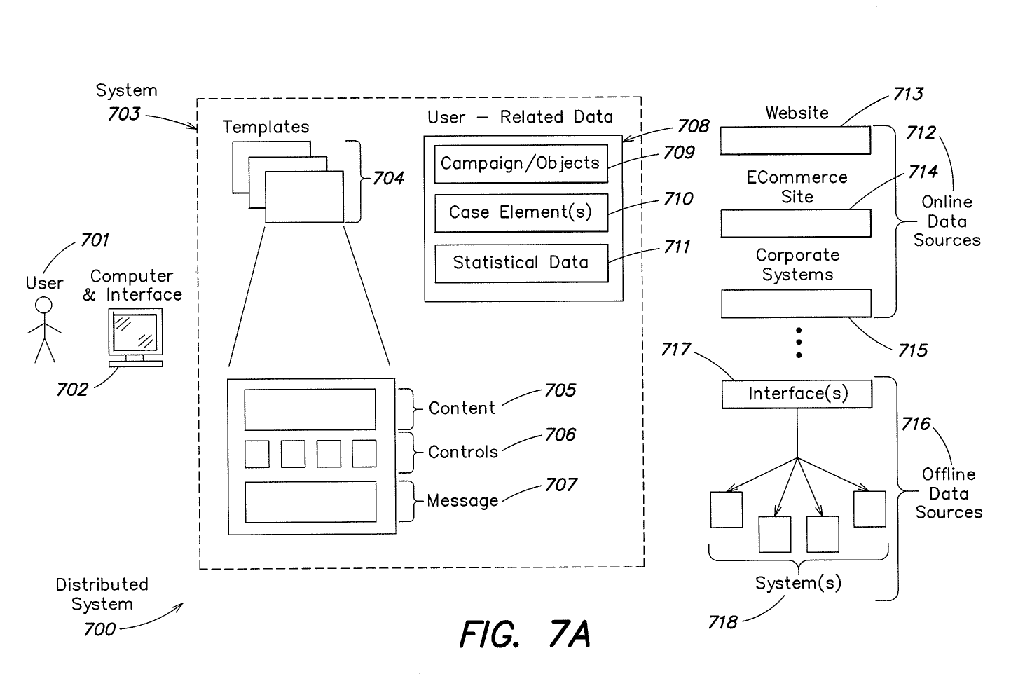

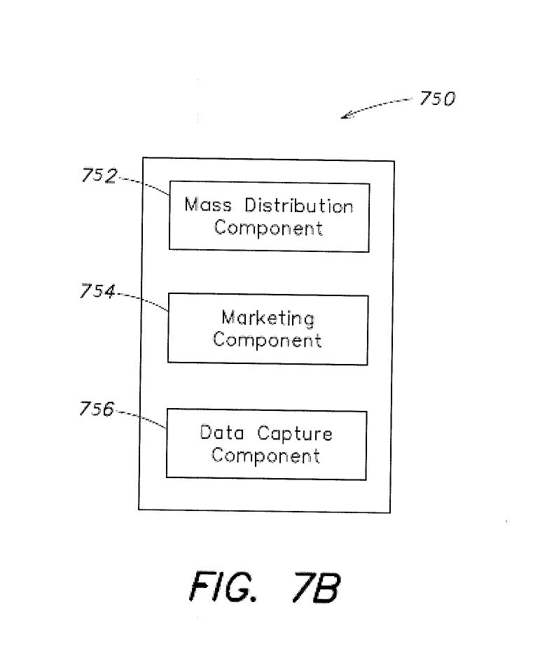

FIG. 7A shows one embodiment of a distributed system 700 according to one embodiment of the invention. User 701 operating a computer and interface 702 may access system 700 for the purpose of communicating with one or more other users. System 703 may include a number of components that permit the user 701 to create and communicate objects. For instance, system 703 may include one or more templates 704 that may be modified by user to create an object. The templates may include one or more display elements. For instance, the template may include a document type having one or more areas to display content (e.g. content area 705), one or more controls (e.g., controls 706), and one or more areas that the user can create messages to other users (e.g., message area 707).

For example, a user may be permitted to embed one or more elements such as pictures, video, text or other information that may be shared with other users. In one embodiment, controls 706 may include one or more programmable elements that, when viewed and selected by other users, allows the receiving user to perform one or more actions with the object. For instance, control 706 may include one or more social media actions that can be performed such as a share or a post (e.g., in FACEBOOK). Other actions may be performed, and the system may include programmable elements that can be inserted into the object and shared with other users.

System 703 may also include one or more sets of user-related data 708 which may include, for example, one or more campaigns or objects that are created by the user (e.g., campaigns/objects 709), one or more case elements (e.g., elements 710) that perform one or more functions (e.g., tracking of object accesses, collection of user and system data, among other functions), and one or more sets of performance data such as statistical data (e.g., data 711).

Further, system 703 may be integrated with one or more online data sources 712 and one or more off-line data sources 716 for the purpose of determining when users interact with particular objects, or perform other actions as a result of their interaction with such objects (e.g., a receiving user performs a transaction). For instance, system 703 may be integrated with one or more websites 713, e-commerce sites (e.g., e-commerce site 714), one or more corporate systems 715, among others. System 703 may be integrated with one or more off-line data sources such as those provided by specialized systems (e.g. system 718—which can include any off-line source (e.g., database for a carrier's rating product)) through one or more interfaces (e.g., interfaces 717). Through such capability of being integrated with both online and off-line data sources, the system is capable of tracking behavior and determining a series of behaviors that may result in an interesting action for the user.

Shown in FIG. 7B is a block diagram of a system for managing trackable digital objects. According to one embodiment, a system 750 for managing trackable digital objects can include a variety of components. In one example, the system 750 can include a mass distribution component 752 configured to provide simple and self service object generation tools to create any form of trackable digital object the user wishes to promote. For example, a user can share and/or endorse information on their favorite product or recent purchase by creating a trackable digital object for distribution through social media channels, email, mobile platforms, etc. The user can access the distribution component to create an object and ask their connections to take an action associated with the object (e.g., visit the site, review the product description, and share the object with more friends, among other options). In some embodiments, each user access to the digital object is tracked through response data reported back to the system. In some further embodiments, each interaction that results from the digital object (e.g., access to an identified web-site, purchases at an identified web-site, etc.) can also be tracked, attributed to the object generator, and reported back to the system. The response data enables users to understand, measure, and derive value from their influence. Further, the response data can also be used by enterprises to determine accurate valuation for that user's influence, permitting greater rewards/incentives based on reliable metrics.

According to another embodiment, the system can also include a marketing component 754 that is configured to provide users selectable marketing templates and/or recommend marketing actions that are tied to direct rewards to the user originating the trackable digital object. For example, the user can select a “recommend product” template, which generates a discount award responsive to any of the user's connections making a purchase traceable to the user's digital object.

According to another embodiment, the system can include a data capture component 756 configured to capture data resulting from user interaction and/or connection interaction with trackable data objects. In one example, the data capture component can be configured to receive and analyze data results returned from various interactions with a data object. Selection of the data object can be recorded (e.g., execution of a hypertext link embedded in the object, sharing of the object, posting to a social media site, etc.). In another example, a data object can be associated with a web address hosted by the system. The system can capture all activity performed on the hosted page and associate the activity with the originating user.

In one embodiment, the system is configured to generate tracking code and/or tracking executables in conjunction with generating digital objects. The tracking code and/or executables can be incorporated into existing web pages to provide tracking of activity on sites external to the system. In one example, a user refers a friend to an enterprise web site through a digital object. Selection of the digital object can be tracked by the system, for example, via a hosted page, however, activity on the enterprise site can be lost without additional functionality. Accordingly, various embodiments provide for tracking scripts that can be provided to the enterprise hosting their respective site. By including the tracking scripts (e.g., copy and paste tracking code into their web page source code) activity on the enterprises web-site can be captured for use by the system. In some examples, rich meta-data is captured during the friend's interaction with the enterprise site. The rich metadata can include any information that is accessed by the friend and can also include additional information, for example, how long the friend was on the site, information accessed, viewed pages, dwell time, referrals, etc. In one example, the meta-data includes information on purchases made at the enterprise site and can include price paid for any service or good. In one embodiment, capturing actual sales information improves the systems capability to value the originating user's influence. Actual sales figures can be attributed to the originating user (e.g., the generator of the trackable object) and quantifiable metrics generated against that information.

According to another aspect, trackable digital objects and tracking code embedded in external sites enables the system to gather multiple behavioral data sets and attribute that data to individuals visiting their sites. In addition, through “digital fingerprinting” and personal data stores, behavioral data can be tracked across multiple sites and attributed to events/actions/activities that result from user interaction with those sites. The tracking can be configured to execute against any number of external channels, such as affiliate sites, blogs, and any other web property that can link to an enterprise web-site. In some embodiments, the tracking and reporting functions provided by the system enable cross-platform tracking, sharing, and engagement with the enterprise's site content, among other options.

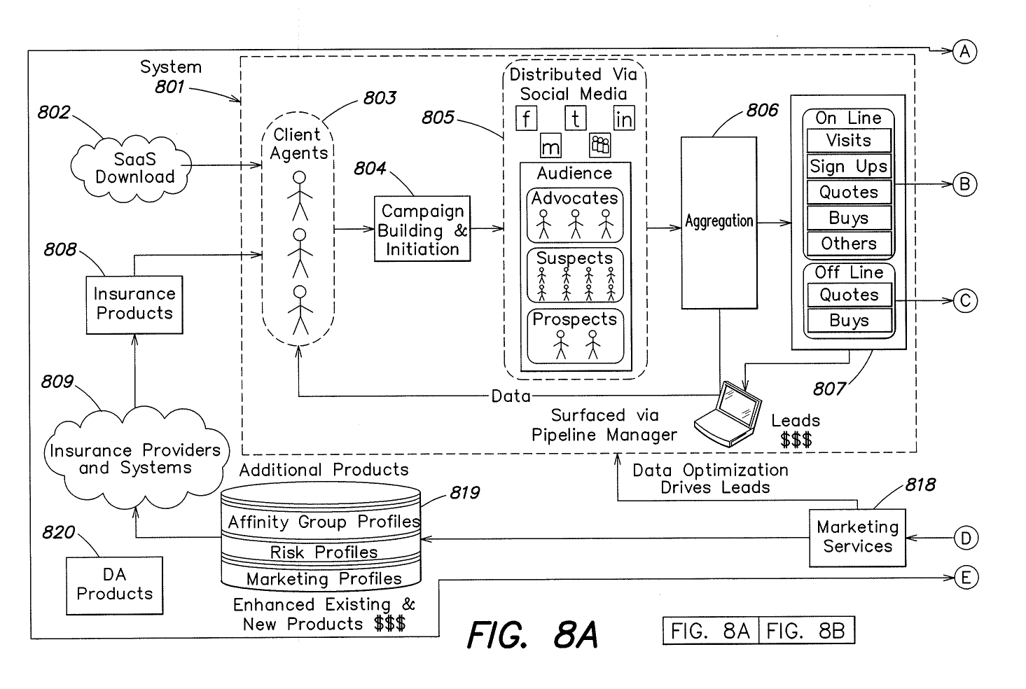

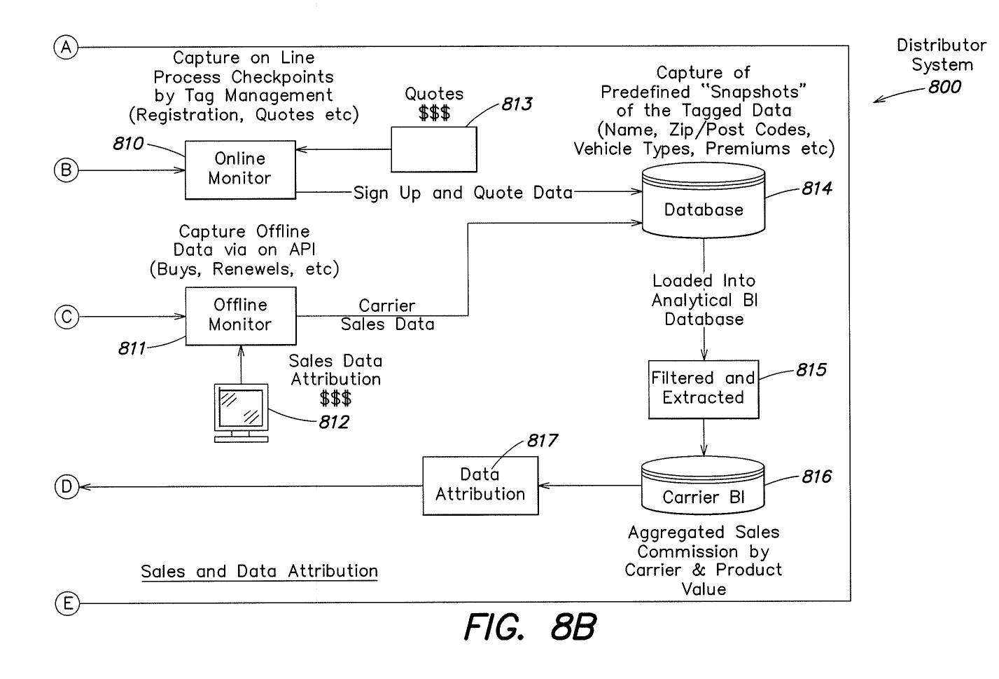

FIGS. 8A-8B show an example system implementation in the area of insurance. For instance, aspects of the present invention may be used by agents to engage clients of insurance products to increase sales and client engagement. In one example, one or more client agents (e.g., 803) may use one or more systems (e.g., 801) for accessing tools for creating and communicating campaigns. In one implementation, such tools may be provided to users as a Software as a Service (SaaS) download (e.g., at 802) that may be performed on a computer system. A particular agent/user may build a campaign object using the tools (e.g., at 804) and may communicate the campaign using one or more channels (e.g., via one or more social media systems). Such campaigns may be communicated to different audience types such as advocates, suspects (e.g., possible customer whose intent is unknown) prospects (e.g., people likely to buy). The suspect is engaged and/or signs up and becomes a prospect. When that prospect is directed to a quote page, for example, they become a lead attributed by the system. The system provides the integration tools, for example, for agents to manage system attributed leads within their enterprise systems, performing certain functions, for example, incorporating the lead and all associated engagement data in a leads management product. In one example, when the lead requests a quote, the ID and quote data of the user is forwarded to a rating system. Responsive to the policy containing the insurance product being bound by the carrier, the sale of the insurance product can be attributed by the system, even from an offline data source. In one example, off-line capture can be executed by customized API interfaces.

Information regarding the users is aggregated for the campaign and objects are forwarded to such users. Their online and offline actions are observed and tracked (e.g., at 807). In the case of insurance products, actions such as online visits, sign ups, quotes, buys, and other interesting actions may be observed and tracked. Further, offline actions such as quotes and buys of insurance products may also be tracked (e.g., via APIs to other systems) and included in the analysis of campaign and user performance.

Online process checkpoints may be captured by monitoring accesses to the created campaign objects using tag management. Such monitoring may be performed by one or more integrated components with other online systems, and may be tracked and stored by an online monitor 810. For example, each time a quote is provided online, sign up and quote data is stored in a database (for instance, database 814). For instance, snapshots associated with interesting actions is collected over time, and such snapshots may include user data, such as name, location, residence address, postal codes, or other information relating to the sale of insurance (e.g., vehicle types, age, miles, premiums paid, etc.).

Such information may be collected and stored for each of these actions in a business intelligence (BI) database where advance analytics may be performed. For instance, data from each of these actions may be filtered and extracted depending on the information needed to be observed. Information for multiple users and multiple campaign objects may be aggregated with other users and campaigns for an assessment by an entity (e.g., a carrier to determine sales commission due to an agent based on products sold, product value, and other information). To this end, a carrier or other database type (e.g., carrier BI data set 816) may be stored that determines attribution and credit to particular agents. Data regarding such attribution (e.g., data 817) may be provided within an interface or shared as a report. Alternatively, such attribution data may be provided to another system to determine a payment, award, credit, bonus or any other item of value to the appropriate user. Also, attribution and performance information may be analyzed in a number of dimensions, such as by user, group, channel, transaction value, geographical reach and influence of the user and their network, among other information.

Such attribution information may be used as an input to marketing services (e.g., 818) to improve marketing efforts, improve and enhance existing and new products (819), generate leads, may be provided as feedback to insurance providers and systems (809) to provide improved insurance products (808) or may be otherwise used to improve customer engagement.

According to one embodiment, the system provides a mechanism to capture Internet Browser events on a web based system and associate them back to an individual user that instigated the engagement with the web based system via the user's engagement with digital/shared objects. Thus, various embodiments are configured to capture behavioral user data. The shared objects can include any user defined message, media, content, or other information containable in a web based environment. Individual user and object data is associated with data derived from user instigated events, user journeys/paths and the data from third party users re-sharing, clicking, and/or interacting with the objects. In some embodiments, the user originated behavioral data is captured when a web based document loads. For example, the system can be configured to capture any pre defined variables within the loaded web based document. The pre defined variables can include environmental data associated with the loaded web page (e.g., browser, browser trail, browser history, location, time, starting page and/or site, media channel (e.g., FACEBOOK, TWITTER, social media site, etc.), user system details, etc.).

According to some embodiments, the combined behavioral and environmental data set can be centrally tracked by the system and reported in various dimensions; for example: location (geographical), time based events, links originating from web based communication systems (e.g., FACEBOOK, TWITTER, e-mail sites, email, etc.), and other web based communication systems. Further the combined behavioral and environmental data can be used by the system to provide accurate reporting on individuals influence on their peers. In some examples, influence can be measured by the system on the relative values of user defined actions resulting in a desired outcome on the users' behavior. The reporting outcome of the combined data set will allow a user to define the relative influence of a third party user on their peers and track the relative influence of all users, and the demand of all objects in a user defined data set.

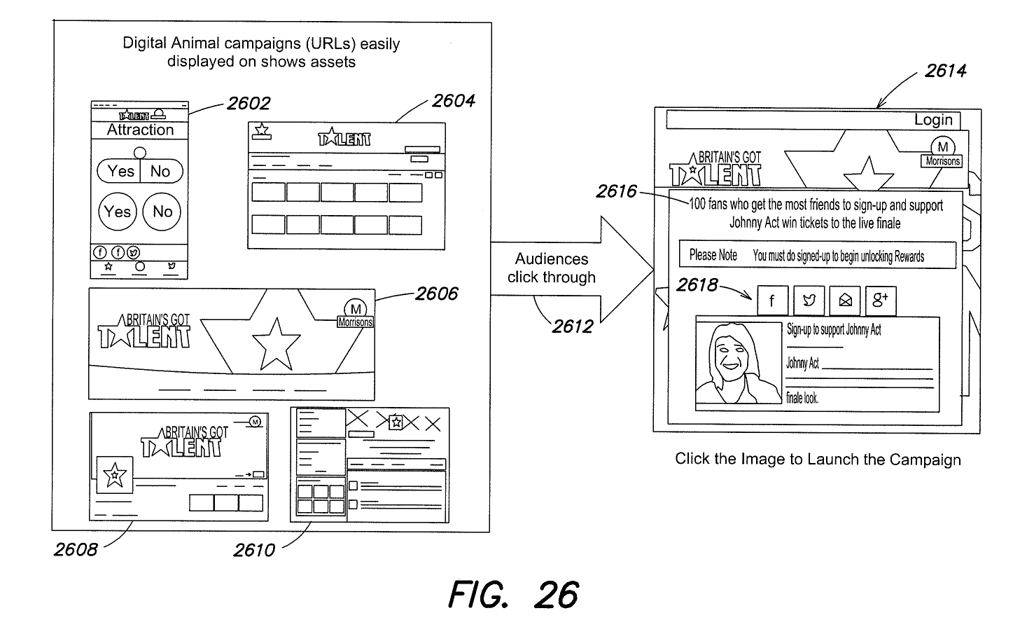

FIG. 26 illustrates elements of a “social voting” use case. According to some embodiments, implementation and/or use of trackable digital objects enables various social voting use cases instead of conventional voting approaches. For example, systems for distributing digital content can be used in conjunction with the well known American Idol or Britain's Got Talent. Under conventional approaches, contestant advance through these shows based on audience voting. Typically, audience members “phone-in” their votes. Conventional “phone-in” voting is perceived as old fashioned, and is further discouraged by associated charges.

According to some embodiments, social voting changes phone-in approaches by enabling a promoter (e.g., an entity running, for example, the show) to create a master fan distribution campaign. Participants wishing to promote their contestant or to be rewarded for their influence over their connections can register to participate through the master campaign. The master campaign can be configured to provide template selections to registering users. For example, the template selections can be configured to enable a participant to select from a number of contestants and generate objects for distribution into their social connections. Responsive to selection, the system can display fan distribution campaigns that are attributable to the registered participant and trackable across a plurality of electronic distribution channels. Thus, audience members can fully engage their contacts and combine television entertainment with social media activity.

In FIG. 26, a participant can access a promoter's web-site (e.g., an entity responsible for the event, show, etc.) and register their “social vote” by signing up to a fan distribution campaign. For example, in the context of social voting, the system enables users to visit hosted web-sites (e.g., 2602—mobile site for Britain's Got Talent, 2604—website for Britain's Got Talent, 2606—YOUTUBE page for Britain's Got Talent, 2608—FACEBOOK page for Britain's Got Talent, and 2610—TWITTER feed for Britain's Got Talent, among other examples) identify and/or create a campaign to participate in (e.g., “Support Johnny Ace”) and responsive to user selection 2612, display to the participant a user interface for generating and delivering their own fan distribution campaign (e.g., trackable digital object). For example, shown at 2614 is a user interface for injecting a trackable digital object into a user's social media network. A potential reward can be pre-determined by the campaign sponsor and/or promoter (e.g., 2616—“100 fans who get the most friends to sign-up and support . . . win tickets to the live finale”) and displayed in the user interface 2614. As shown in FIG. 26, the user interface is configured to distribute the fan distribution campaign across a plurality of selectable networks (e.g., at 2618—FACEBOOK, TWITTER, e-mail, GOOGLE+, among other options). In some examples, the networks displayed can be based on participant registration information.

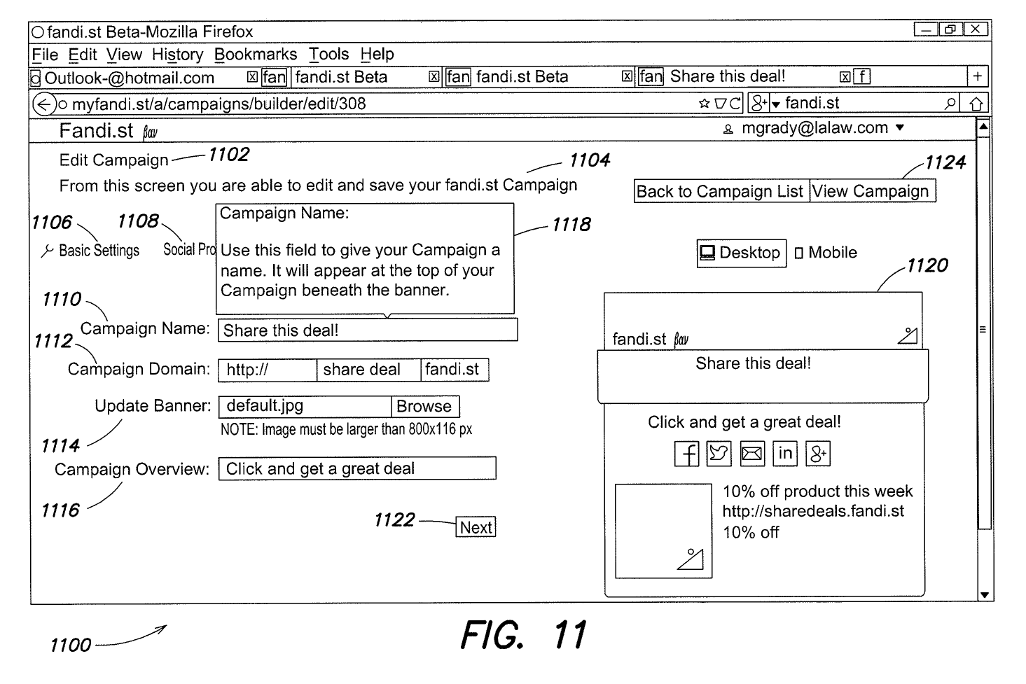

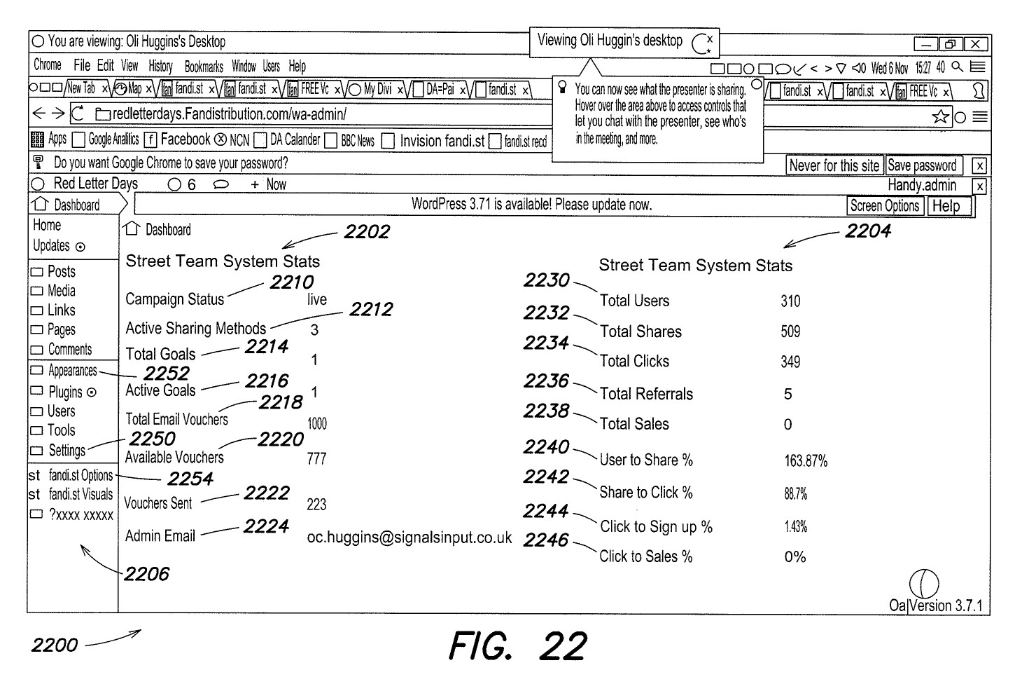

In one example, if the user provides registration information for any of the above communication channels, they can be displayed by the system in the user interface. Alternatively, primary communication channels can be pre-selected for display in the user interface 2614, and if the participant has not completed the necessary registration information, the participant can be prompted by the system to input their information associated with a selected communication channel responsive to selection of the respective communication channel (e.g., at 2618). According to other embodiments, a participant in social voting or other fan distribution campaign context can access a number of user interfaces to define a deal they wish to share, a contestant they wish to endorse, a product to endorse, among other options. FIGS. 11-21 and their associated descriptions, describe example user interfaces for creating, managing, and distributing fan distribution campaigns (e.g., trackable digital objects). FIGS. 22-25 provide examples of user interfaces for managing information tracked on fan distribution campaigns. For example, the promoter (e.g., an entity running, for example, the show) can manage information received from the trackable digital objects distributed by various participants via user interfaces 2200-2400). According to some embodiments, the promoter can identify their most influential participants based on a variety of metrics (e.g., most shares, most clicks, most referrals, most sales (if applicable), most sign ups from clicks, most sales from clicks, most votes, etc,). In the social voting setting, the most number of shares and/or highest percentage of votes based on shares can be used to drive rewards to respective participants. In one example, the top 100 participants measured by sign-ups and votes win tickets to the live finale of the show (e.g., 2616). In other examples, other rewards and other metrics can be used.

In another voting scenario, participants can access any voting site hosted by promoter. For example, a show viewer can sign-up to become micro-affiliates and/or advocates of their preferred contestants. According to one embodiment, the viewer registers under a campaign master (e.g., a master campaign created, for example, by the promoter) and accesses the user interfaces provided to generate their own fan distribution campaign. The viewer can then distribute a link to their campaign to their networks (e.g., FACEBOOK, TWITTER, LINKEDIN, GOOGLE+, e-mail channel, PINTEREST, MYSPACE, VINE, SNAPCHAT, etc.) and encourage their friends to sign-up to their campaign. Users who access the link are tracked and attributed to the originating viewer (e.g., the viewer who registered and distributed the campaign) based on, for example, attribution information embedded in the link being shared.

Each viewer that registers and distributes a respective campaign has registered their vote by signing up and broadcast their support through their network. Further, these viewers and/or the promoter are now able to track any interaction with the distributed campaigns. Thus, voting in these scenarios becomes a social exercise referred to as social voting. As discussed above, the tracking of interactions with the fan distribution campaigns (e.g., trackable digital objects) occurs across a variety of social media platforms, and can even reach into e-mail distribution settings.

According to some embodiments, social voting can include additional features to augment the social voting aspects. For example, each participant who signs up to distribute a campaign can be incentivized to share and encourage their friends to sign-up and vote. Promoters can define one or more goals, or number of goals, wherein progress towards the achievement of the goal can be reported to the participant. For example, trackable digital objects can capture information on any downstream interactions (e.g., further shares within a social media channel, clicks on the embedded links in the distributed campaign, votes on the promoter site where the vote is attributable to the distributed campaign (e.g., the site is reached via a click on an embedded link in a distribution campaign). In some embodiments, data can be captured and/or aggregated by a data capture component (e.g., 756). As each goal is reached or nearing completion, the system can be configured to generate notifications to the participant.

According to one example, the system can be configured to measure the “shares” that each signed-in viewer makes, and can automatically generate an e-mail when the predefined reward is reached. In further examples, a viewer (e.g., a registered participant) can be rewarded for making their first share by being e-mailed with a customer wallpaper for their desktop (e.g., the custom wallpaper can be selected based on a promoted contestant) or any e-mail message (e.g., a personalized “thank you” from their promoted contestant, among other options).

In another example, the system can measure clicks on the link shared via the trackable digital object, thus rewards can be configured for achieving a set number of clicks. In some embodiments, a promoter can establish rewards and/or goals, the details (e.g., thresholds) for achieving one or more awards, as part of creating a master campaign. Various parameters can be associated with rewards and/or goals. For example, the system collection information on new sign-ups associated with a shared campaign. The system is configured to allow users to tailor rewards for achieving a set number of sign-ups. User can be notified by the system when the signed-up viewer's shared campaign has been signed-up to by 5 (e.g., or other minimum threshold) of their friends. The reward can include digital content tailored to the participant (e.g., a link to a secret video of the contestant). In other examples, a reward could be made to the top 100 (e.g., or other minimum threshold) signed-up viewers who get the most of the friends to sign-up to their preferred contestants campaign. In another example, the top 100 could be rewarded by receiving tickets to the shows live finale.

According to one aspect, social voting can be used to increase engagement with viewers by giving them the opportunity to support their favored contestant. Viewers (e.g., fan distribution participants) use and/or measure their influence in social media, over and above merely registering votes. The opportunity to score their own influence and/or to obtain rewards from participation encourages increased activity among viewers (and not just when the show is on air), increase awareness of the show and its contestants and ultimately either increased ratings or a stem in the decline of ratings.

According to some embodiment, the system enables better tracking of voting through trackable digital objects. For example, the system is configured to track and “de-duplicate” voting. In further examples, the system is configured to count one vote per user sign up. Because user journeys can be track using digital objects, the system is configured to identify duplicate voting attempts. Conventional voting systems/methods are not able to identify the voter in all cases, and thus it is not possible to de-duplicate votes.

In further embodiments, the system is configured to identify users who sign-up and attribute interaction activity to the originating user. The system is configured to manage and store this information, for example, as a database of engaged individuals together with data showing just how influential each of them are (for example, Joe Smith shared 25 times, yielded 200 clicks on his shared message and generated 30 new sign-ups from his activity). In one example, a leader board or a league table of influencers can then be created by the system enabling rewards to be made to the leaders and allowing the leaders and close participants to compete over leader based awards.

According to another aspect, the system captures information on users and their influence which can be used to by sponsors to reach into viewers' networks by attaching sponsored links to the shared campaign messages.

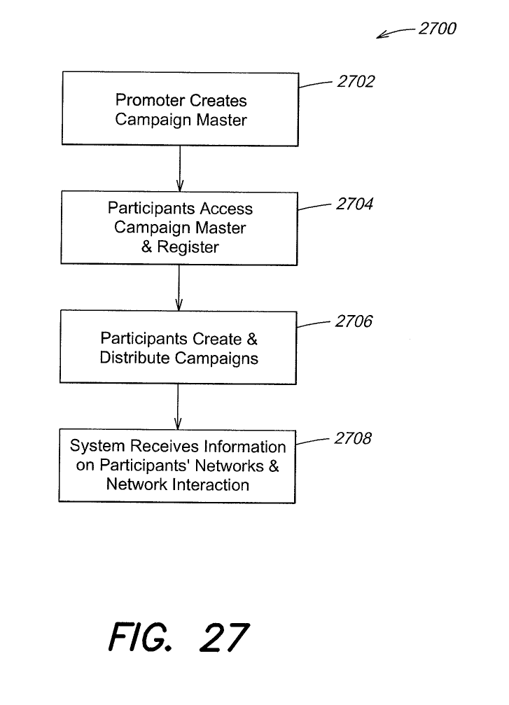

FIG. 27 is an example process 2700 for capturing information from trackable digital objects. The process 2700 begins at 2702 with a promoter (e.g., a show sponsor, a retailer, a distributor, an advertiser, etc.) creating a campaign master, for example, on a distribution system (e.g., 700, 703, 750, among other examples). The campaign master established parameter for participants to register and participate in campaign distribution. In some examples, the promoter established campaign object that participants can select as part of 2702. In other examples, the promoter defines template that participants can uses to create their own custom distribution campaigns. In addition to defining visual arrangements, organization of information, etc. as part of a campaign template, the promoter can establish rewards, goals, and/or incentives that are available to participants at 2702. For example, the promoter may offer free tickets to the top 100 participants as measure by number of shares of their respective distribution campaign.

Once a campaign master is created, participant can register to participate in campaign distribution. For example, the promoter can create the campaign master and host the campaign master within their own domain or provide access to the campaign master through their own domain. At 2704, participants access the campaign master and register to participate. In some examples, the participants must first register in order to participate. Registration at 2704 can include providing information on social media services subscribed to by the participant (e.g., account information for any one, two, three, four, five, six, all, or more of FACEBOOK, TWITTER, LINKEDIN, VINE, SNAPCHAT, PINTEREST, YELP, etc.). In further embodiments, registration can include capturing information on a participant's e-mail accounts, messaging services, etc.

At 2706, registered participants can create and distribute their own campaigns. In one example, the participant can selection a contestant that they wish to vote for and/or endorse. Responsive to selection of the contestant, a campaign distribution user interface can be presented. The participant can select text to include, customize messages, and identify media channels to which to distribute the participant's campaign. Responsive to selection in the UI, the participant can launch the campaign into his or her social media networks.

At 2708, the system receives information on any activity derives the participants' networks. For example, embedded links within the campaigns are uniquely associated with the participant who generated and/or distributed them. In some examples, the links are also unique to the media channel in which they are distributed. In some settings, the link used to access a distribution campaign can provide information on the originating user who created it, and the media channel the clicking users used to access the campaign. In some embodiments, the promoter who started the master campaign can access information aggregated across all the participants. In further embodiments, the participants can access activity information generated from their respective social networks. The participants can then evaluate their own influence.

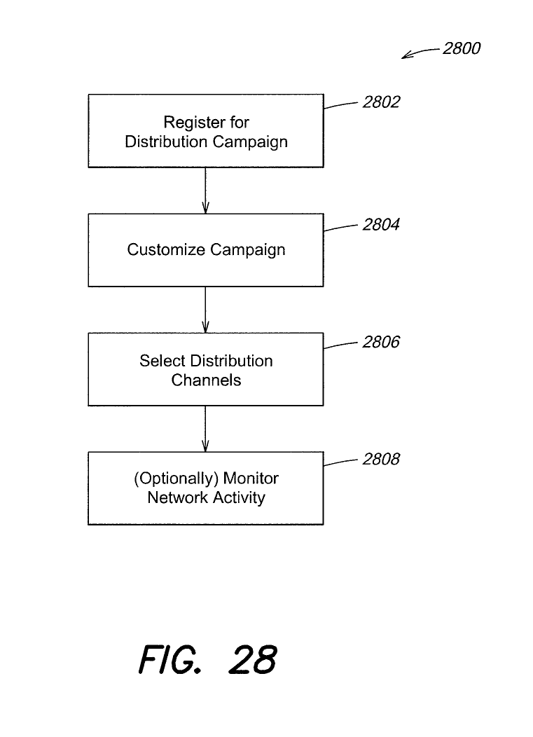

FIG. 28 is an example process 2800 for creating and distributing a fan distribution campaign. The process 2800 beings at 2802 where a user registers, for example, on a distribution system (e.g., 700, 703, 750, etc.). Once registered, the user can create or customize their own campaign at 2804. In some examples, the user can select from a plurality of campaign templates. In other examples, the user can generate a custom campaign that allows the user to deliver a message, promotion, activity, etc. to their social networks. Any activity associated with the campaign can be tracked based on, for example, embedded links. The embedded links can be automatically generated and included in any campaign distribution. As members of the user's network share, click, access, etc. the campaign, the respective activity information can be captured. In some embodiments, the user creating the distribution campaign can monitor the activity that occurs within the network at 2808. In other embodiments, the user registered to participate in a master campaign (e.g., similar to process 2700), and the ability to monitor activity can be dictated by the creator of the master campaign.

### General Purpose Computer Examples

Processes and functions described above are merely illustrative embodiments of systems that may provide user tools and facilities for direct communication and tracking of digital objects between users. Such illustrative embodiments are not intended to limit the scope of the present invention, as any of numerous other implementations for performing the invention. None of the claims set forth below are intended to be limited to any particular implementation, unless such claim includes a limitation explicitly reciting a particular implementation.

Processes, functions, and/or methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, JavaScript, Visual Basic, C, C#, or C++, Fortran, Pascal, Eiffel, Basic, PHP, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, ARM Cortex processor, Qualcomm Scorpion processor, or any other type of processor. It should be appreciated that one or more of any type computer system may be used to partially or fully automate generation, management, and/or distribution of trackable digital objects according to various embodiments of the invention. Further, the system may be located on a single computer or may be distributed among a plurality of computers attached by a communications network. In some embodiments, the functions and features disclosed may be implemented as a cloud based service over a distributed network of computer systems. In some embodiments, the cloud based computer resources can execute functionality, respond to input, output requests, etc. The cloud based resource can include any type of general purposed computer system specially configured to execute the functions, methods, and/or operations described herein.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A computer system may be a general-purpose computer system that is programmable using a high-level computer programming language. Computer system may be also implemented using specially programmed, special purpose hardware. In a computer system there may be a processor that is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 or 8 operating systems available from the Microsoft Corporation, MAC OS X Snow Leopard, MAC OS X Lion operating systems available from Apple Computer, the Solaris Operating System available from Sun Microsystems, iOS Blackberry OS, Windows 7 Mobile or Android OS operating system or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as Java, JavaScript, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Further, on each of the one or more computer systems that include one or more components of a system, each of the components may reside in one or more locations on the system. For example, different portions of the components of system may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

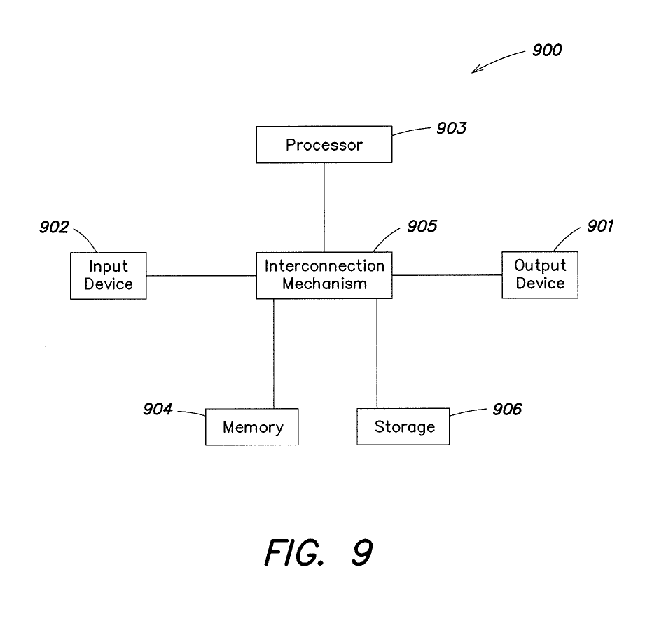

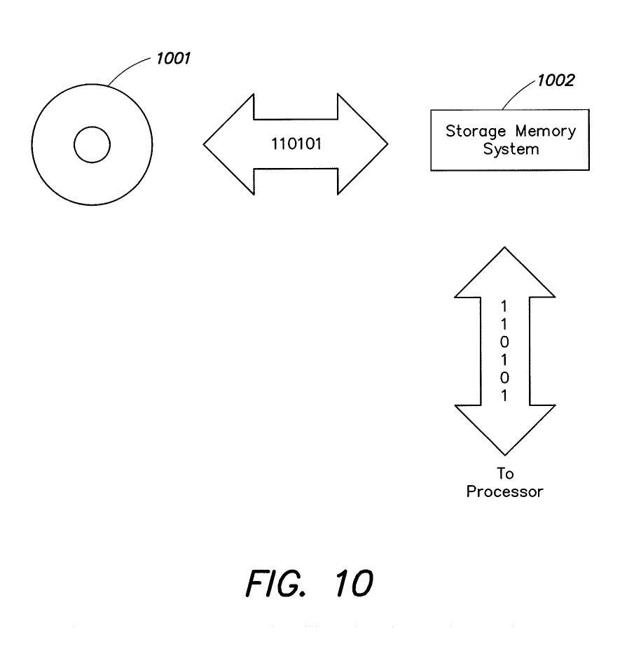

FIG. 9 shows an example computer system 900 on which various aspects and/or embodiments may be practiced. FIG. 10 shows an example storage system that may be used.

System 900 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to provide tools and services for creating, distributing and tracking digital objects according to various embodiments of the invention. Further, the software design system may be located on a single computer or may be distributed among a plurality of computers attached by a communications network.

For example, various aspects of the invention may be implemented as specialized software executing in a general-purpose computer system 900 such as that shown in FIG. 9. The computer system 900 may include a processor 903 connected to one or more memory devices 904, such as a disk drive, memory, or other device for storing data. Memory 904 is typically used for storing programs and data during operation of the computer system 900. Components of computer system 900 may be coupled by an interconnection mechanism 905, which may include one or more busses (e.g., between components that are integrated within a same machine) and/or a network (e.g., between components that reside on separate discrete machines). The interconnection mechanism 905 enables communications (e.g., data, instructions) to be exchanged between system components of system 900. Computer system 900 also includes one or more input devices 902, for example, a keyboard, mouse, trackball, microphone, touch screen, and one or more output devices 901, for example, a printing device, display screen, and/or speaker. In addition, computer system 900 may contain one or more interfaces (not shown) that connect computer system 900 to a communication network (in addition or as an alternative to the interconnection mechanism 905.

The storage system 906, shown in greater detail in FIG. 10, typically includes a computer readable and writeable nonvolatile recording medium 1001 in which signals are stored that define a program to be executed by the processor or information stored on or in the medium 1001 to be processed by the program. The medium may, for example, be a disk or flash memory. Typically, in operation, the processor causes data to be read from the nonvolatile recording medium 1001 into another memory 1002 that allows for faster access to the information by the processor than does the medium 1001. This memory 1002 is typically a volatile, random access memory such as a dynamic random access memory (DRAM) or static memory (SRAM). It may be located in storage system 906, as shown, or in memory system 904, not shown. The processor 903 generally manipulates the data within the integrated circuit memory 904, 902 and then copies the data to the medium 1001 after processing is completed. A variety of mechanisms are known for managing data movement between the medium 1001 and the integrated circuit memory element 904, 1002, and the invention is not limited thereto. The invention is not limited to a particular memory system 904 or storage system 906.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 900 is shown by way of example as one type of computer system upon which various aspects of the invention may be practiced, it should be appreciated that aspects of the invention are not limited to being implemented on the computer system as shown in FIG. 9. Various aspects of the invention may be practiced on one or more computers having a different architecture or components that that shown in FIG. 9.

Computer system 900 may be a general-purpose computer system that is programmable using a high-level computer programming language. Computer system 900 may be also implemented using specially programmed, special purpose hardware. In computer system 900, processor 903 is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 operating systems available from the Microsoft Corporation, MAC OS Snow Leopard, MAC OS Snow Lion operating systems available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. Other models (e.g., a SaaS model) may also be used. These components may be executable, intermediate (e.g., IL) or interpreted (e.g., Java) code which communicate over a communication network (e.g., the Internet) using a communication protocol (e.g., TCP/IP). It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as Java, C++, Ada, or C# (C-Sharp). Other object-oriented programming languages may also be used. Alternatively, functional, scripting, and/or logical programming languages may be used (e.g., JavaScript). Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

### Example System Interfaces

As discussed above, various embodiments of the system provide self service tools for creating trackable digital objects. In some embodiments, user interfaces provided by the system are configured to simplify creation of trackable digital objects targeting any type of good or service the user wishes to promote. According to one embodiment, a user becomes an advocate for a product or service by creating a trackable digital object. In another embodiment, the user can generate game like trackable digital objects for distribution to their contacts (e.g., social networks, e-mail contacts, etc.) to measure the user's influence.

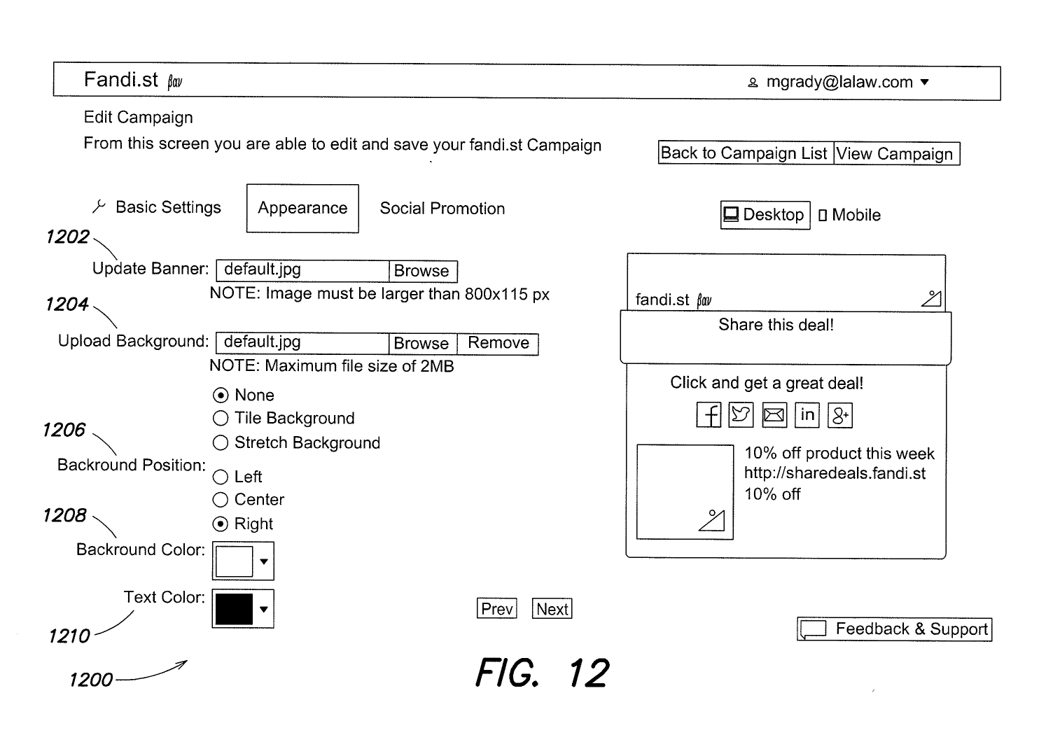

Shown in FIGS. 11-25 are screen captures of example user interfaces. FIG. 11 illustrates a campaign creation user interface 1100. In one example, new users can be presented with the campaign creation screen 1100 upon registration. In some embodiments, the campaign creation screen can be titled “Edit Campaign” (e.g., at 1102), which can be accompanied by an explanation of the purpose of the user interface (e.g., at 1104—“From this screen you are able to edit and save your fandi.st Campaign). As discussed, users can create any kind of campaign, and set any type of action or goal to associate with the campaign. In the illustrated example, the campaign is configured to target a product or service. The user begins with entering basic setting information. The user interface can include multiple tabs separating the information that the user needs to enter into multiple screens (e.g., tab 1106 “Basic Settings” and 1108 “Social Promotion”). According to another embodiment, additional tabs may be presented to the user, for example, to manage and/or configure the creation of a campaign. In one example, FIG. 12 illustrates a user interface 1200 for specifying appearance attribute of a generated campaign (e.g., upload banner at 1202, upload background at 1204, managing background characteristics at 1206, 1208, and 1210. The user interface may also provide options for managing colors for the campaign at 1212.

Returning to FIG. 11, the user interface 1100 provides text input options from “Campaign Name” (e.g., at 1110); “Campaign Domain” (e.g., at 1112); banner image (e.g., 1114); and a campaign overview (e.g., at 1116). Each field can include an explanation that is displayed as the user accesses it. For example, at 1118 the campaign name explanation can be displayed. According to some embodiments, the campaign overview can provide an explanation of what actions and/or goal the user is trying to achieve, so the user's connections can more effectively help the user achieve that goal and/or action. In further examples, the campaign domain provides for a user customizable system hosted web address. The campaign domain allows the user to define a URL hosted by the system configured to manage and track user interaction. The campaign domain can be embedded in a trackable digital object so initial user interactions occur at a system hosted site. In one example, campaign domains are sub-domains of a system hosted primary domain (e.g., “xxxx.fandi.st”). As discussed, system hosted addresses can be used to provide detailed tracking of access, interaction, actions, activity, etc. with respect to each campaign and any trackable digital object.

As the user has defined the basic information in interface 1100, a preview display of the object is shown at 1120, including the campaign name, banner image, campaign overview description, and a link to the campaign domain (e.g., “xxxxx.fandi.st”). Once the basic information has been submitted the user can select next (e.g., at 1122) to proceed to the next entry screen. Alternatively, the user can select between data tabs (e.g., 1106 and 1108) to navigate between data entry screens. The user can optionally view the campaign as it is being generated by selecting 1124 “View Campaign.” Selection of 1124 transitions the user's computer system to the campaign domain specified at 1112 (discussed in greater detail below).

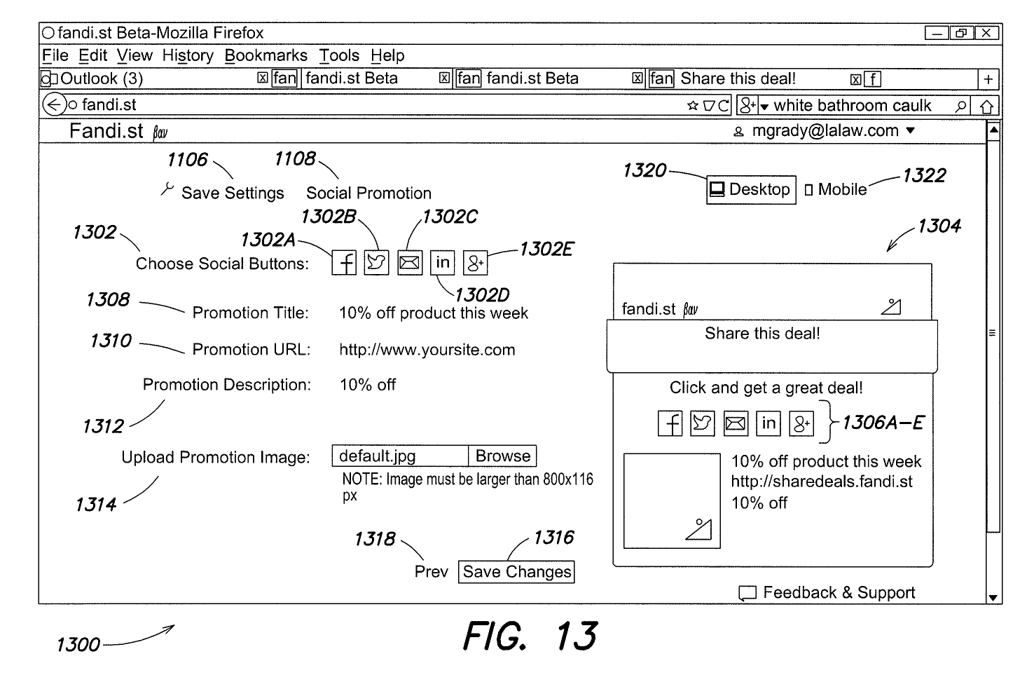

FIG. 13 illustrates an example campaign creation user interface 1300. 1300 is configured for entry of social promotion information. In some embodiments, the social promotion information can be separated from basic information (e.g., using tabs 1106 and 1108). At 1302, social buttons that will be included for sharing a created trackable object are shown. Selection in the user interface at 1302A-E highlights or de-highlights the respective social buttons for inclusion or exclusion.

According to one embodiment, any selection by the user in the user interface is reflected in the preview of the trackable digital object (e.g., at 1304). In particular, social buttons selected for inclusion can be shown at 1306 A-E. At 1308, the user interface displays an entry box for “Promotion Title,” which can be customized by the user to entice their contacts to participate. At 1310, the user interface provides for text entry of a “Promotion URL.” The promotion URL allows the user to define what URL is embedded in the trackable digital object. In some embodiments, this can include an enterprise's web page for purchasing products. In other embodiments, the URL can be directed to a webpage on which the user wishes their contact to take an action.

At 1312, the user interface provides a display for entering a “Promotion Description.” The user interface can also be configured to upload images to include in the digital object (e.g., at 1314). As the user provides description and/or images, the preview of the object at 1304 is updated to reflect user entered information. Once the user is satisfied with the object information, the user can save the object (e.g., at 1316) or return to prior data entry screens (e.g., at 1318). In some embodiments, the system generates digital objects configured to display on specific computer systems, and in particular, desktop formats as well as mobile format. The user interface can be configured to navigate between format and previews. Selection of 1320 displays a desktop formatted object and selection of 1322 displays a mobile formatted object.

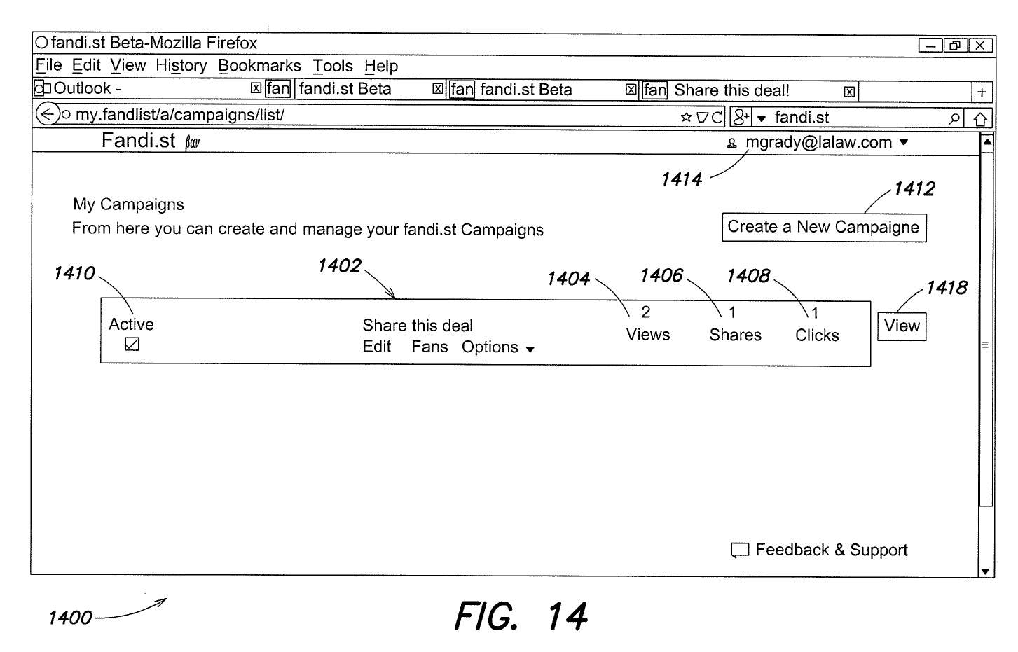

Responsive to selection of “Save Changes” (e.g., 1316) the user interface can be configured to transition the user to a campaign list for managing user defined campaigns. FIG. 14 illustrates an example screen capture 1400 of a user interface for managing user created campaigns. Any number of campaigns can be shown in the user interface 1400. Upon generation of a campaign, each campaign is associated with a trackable digital object and system hosted URL. The generating can access the campaign domain to share the trackable digital object through any of the included distribution channels selected during creation.

According to one embodiment, the user interface provides analysis on how effective any campaign is in reaching contact and/or how influential such interactions are. According to one example, view, shares and click information is displayed for each campaign. For example for campaign 1402 “Share this Deal,” views, shares, and clicks are displayed at 1404, 1406, and 1408. According to one embodiment, the view statistic provides information on how many people have seen your campaign (low numbers can indicate a need for further marketing of the campaign). In another embodiment, the share and click statistics provide information on how many other individuals/entities have shared your promotion and how many of their friends have subsequently clicked on it. In one example, the higher these metrics are, the more viral your campaign is. In further embodiments, transaction metrics can also be displayed, for example, where the campaign is tied to selling a particular product, or to provide information on when another individual actually redeems the shared deal.

In some embodiments, campaigns are not active upon creation. A user can manage the status of their campaigns simply in the user interface 1400. Responsive to selection at 1410 a campaign can be made active or de-activated. The user interface 1400 can also be configured for generation of new campaigns. For example, selection at 1412 (e.g., “Create a New Campaign) transitions the user's computer to a display of a campaign creation user interface (e.g., 1100, FIG. 11). The user can also select a drop down menu at 1414 to transition to campaign creation pages. Additionally, the user can use the menu to view a particular campaign. In some embodiments, user interface 1400 can include a view button at 1418 to transition the user to the campaign domain associated with the viewed campaign. With reference to FIG. 11, the user can access the generated campaign via selection of 1124. Selection of 1124 causes the system to execute a transition to the campaign domain. In one example, the user's computer transitions to the campaign domain using whatever browser is executing on the user's computer system.

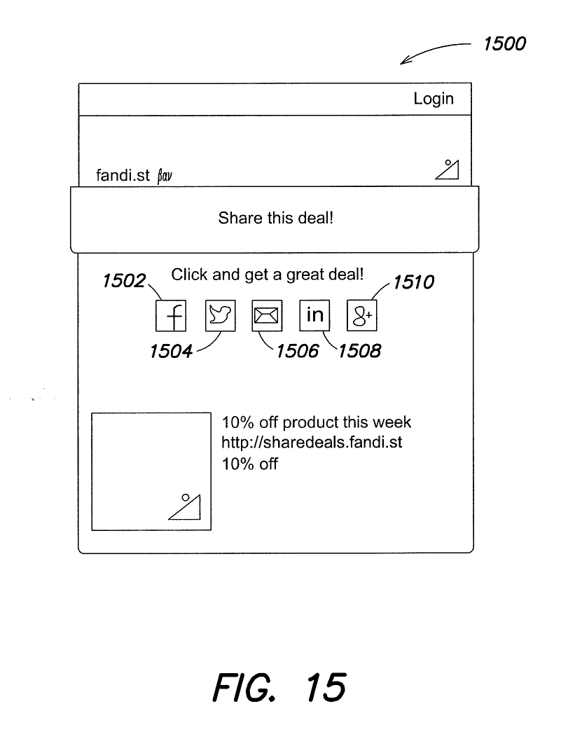

FIG. 15 illustrates a screen capture 1500 of one example campaign domain (e.g., shareddeal.fandi.st/). Shown in 1500 is the user created campaign and the user specified information. According to some embodiments, the user can access the campaign domain to share trackable digital objects. In particular, the user can select 1502 to share a trackable digital object associated with the current campaign via their FACEBOOK account. Selection at 1504 is configured to share the trackable digital object via TWITTER; select at A 406 via e-mail; selection at 1508 via LINKED IN; and selection at 1510 via GOOGLE PLUS.

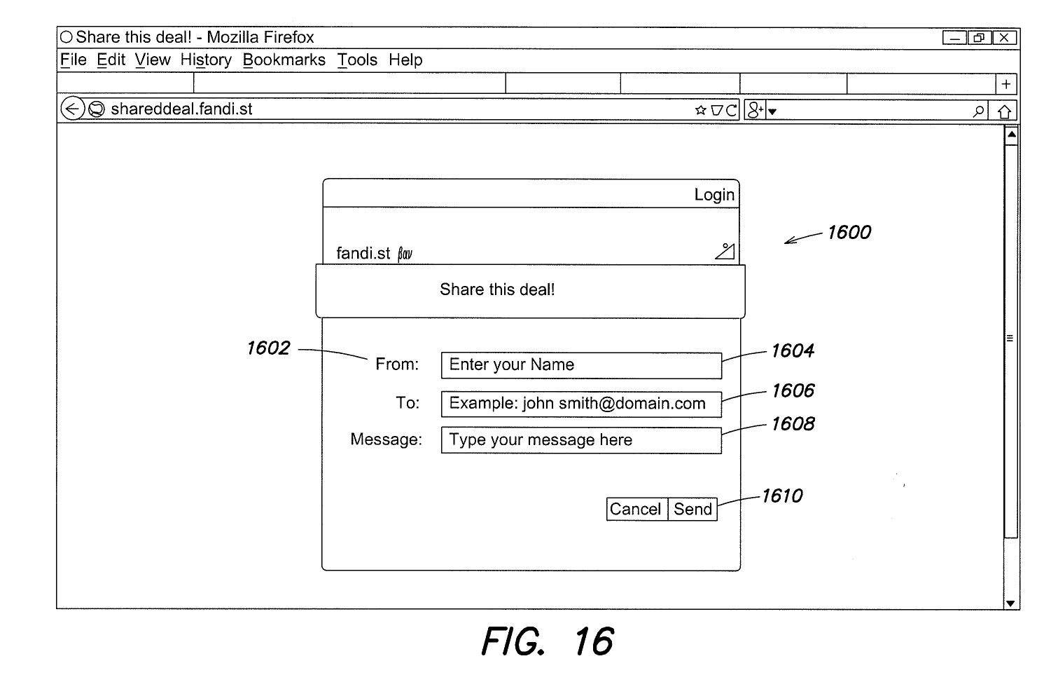

Responsive to selection of a share option (e.g., 1502-1510), the system can be configured to post a trackable digital object to a user account associated with the respective platform. In the e-mail example, posting to a user account is not applicable. For example, in response to selection at 1506, the system generates an e-mail interface or launches the users email client (e.g., shown in FIG. 16) for communicating a trackable digital object to a desired e-mail recipient. Referring to FIG. 16, in one embodiment an overlay display 1602 can be shown. The overlay display provides for user input of name (e.g., at 1604), recipient (e.g. at 1606), and a message (e.g., at 1608). The user can then select send or cancel at 1610 as desired.

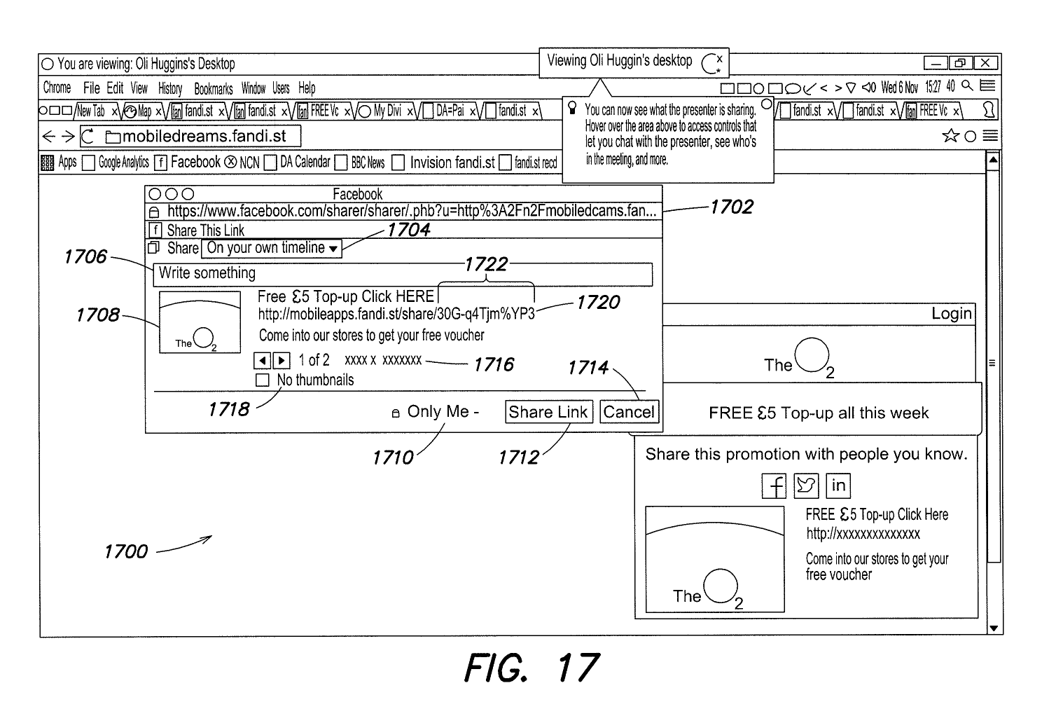

Returning to FIG. 15, digital object delivery can occur via post to a social media site (e.g., via selection of 1502, 1504, 1508, and 1510, among other options). Shown in FIG. 17 is an example user interface 1700 displayed responsive to selection of 1502. According to one embodiment, the user selecting the share button (e.g., 1502) can be required to enter sign-on credentials in order for 1700 to display. Not shown, the system can be configured to access a FACEBOOK account that is currently active. If there is no active account, the system can be configured to prompt the user for sign-in information (e.g., e-mail address or user name and password). According to one embodiment, once an active account is available, the system is configured to display a posting dialogue 1700 configured to the social media platform selected (e.g., FACEBOOK). AT 1702, shown is a URL associated with the post being generated. The posting URL can include information on the campaign and unique information for identifying the user generating the campaign post. The system is configured to access and display the function provided by the selection social media site (e.g., share on your own timeline at 1704, “write something” at 1706, posting constraints at 1710, share 1712, cancel 1714, etc.). In one example, the system generates a thumbnail image 1708 from an upload promotion image (e.g., at 1314 in FIG. 13, although the user can select different images and/or thumbnails as desired at 1716 (including no thumbnail at 1718).

According to one embodiment, the trackable digital object being shared includes a link to the campaign domain (e.g., at 1720). Additionally, the link created by the system and included in the trackable digital object includes unique identifying information for the respective campaign and/or respective campaign generator (e.g., at 1722 a campaign id). Once the digital object is shared (e.g., via selection of 1712) each interaction with that digital object delivers information to the system. The system compiles such interaction information into campaign activity for respective campaigns. According to one embodiment, the unique identifying information for the respective account defines a container tag to associate all interaction information. For example, if another user shares trackable digital object (e.g., the FACEBOOK post) with their friends, the share action is recorded and communicated to the system. Additional information can also be captured and associated with an account container tag. In one example, the container tag is defined at an account level, such that the system can attribute multiple campaigns against multiple actions.

According to some implementations, universal variable keys and data are captured from any web-site associated with trackable digital objects. The known Universal Variable Specification includes descriptions of example data elements, keys, etc. The Universal Variable Specification describes information on a universal variable specification for defining standard web information and is incorporated herein by reference in its entirety. The universal variable specification can include a namespace and universal variable objects for standardizing naming and organization of information. Depending on the webpage being accessed (and site settings for providing information) various fields defined in the universal variable specification can be captured and associated with the container tag on the system. In other embodiments, browser available information can also be captured in conjunction with capturing data described by the universal variable specification.

For example, the information can be captured as user interact with social media posts (e.g., trackable digital objects), with the campaign itself at the campaign domain, and can also be captured on sites external to the system. In one example, external sites are provided tracking scripts for integration into respective external sites. When executed the tracking scripts are configured to provide detailed information (e.g., all available information defined in the universal variable specification) and associate that information with an account container tag. Thus, the system can associate tracking information across multiple media platforms and a variety of external sites. In some embodiments, the system can also track off-line activity with account container tags. In some examples, custom APIs (application-programming interface) are configured to request information from enterprises on their customer's off-line activity. In further examples, the custom API can be provided to enterprises, such that when executed by the enterprise, tracking information is provided to the system.

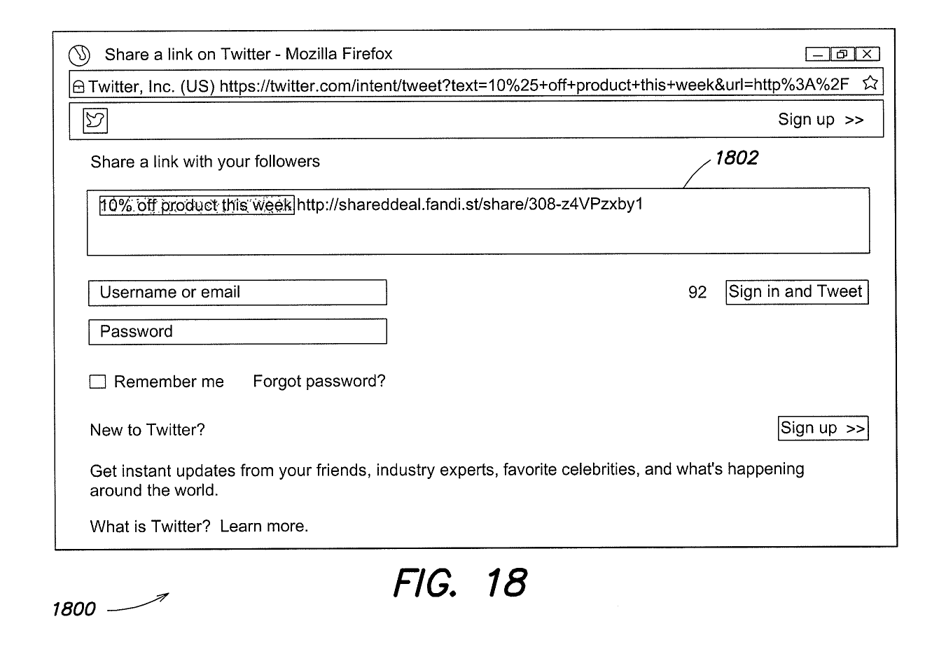

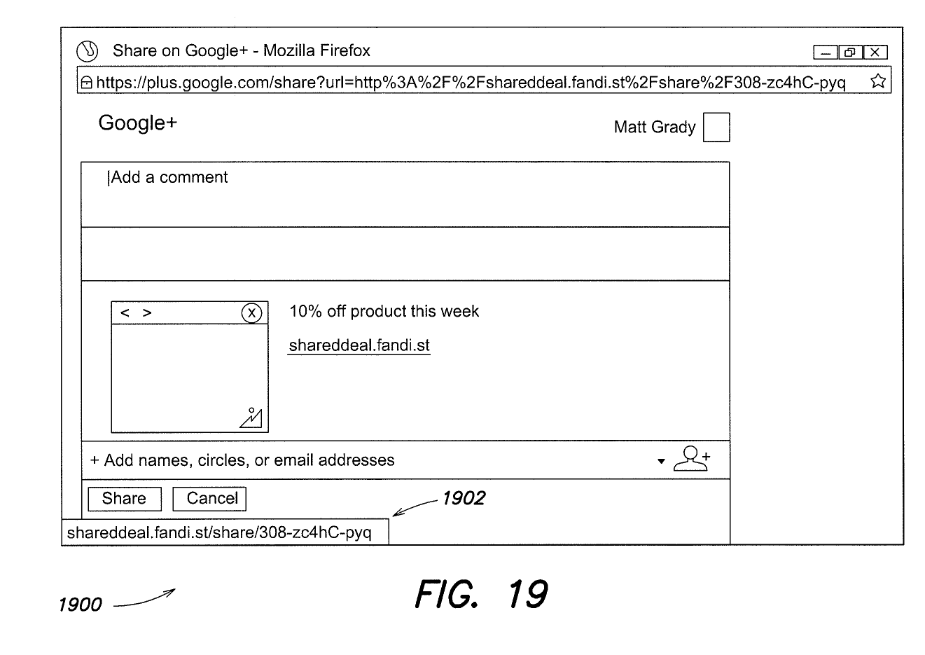

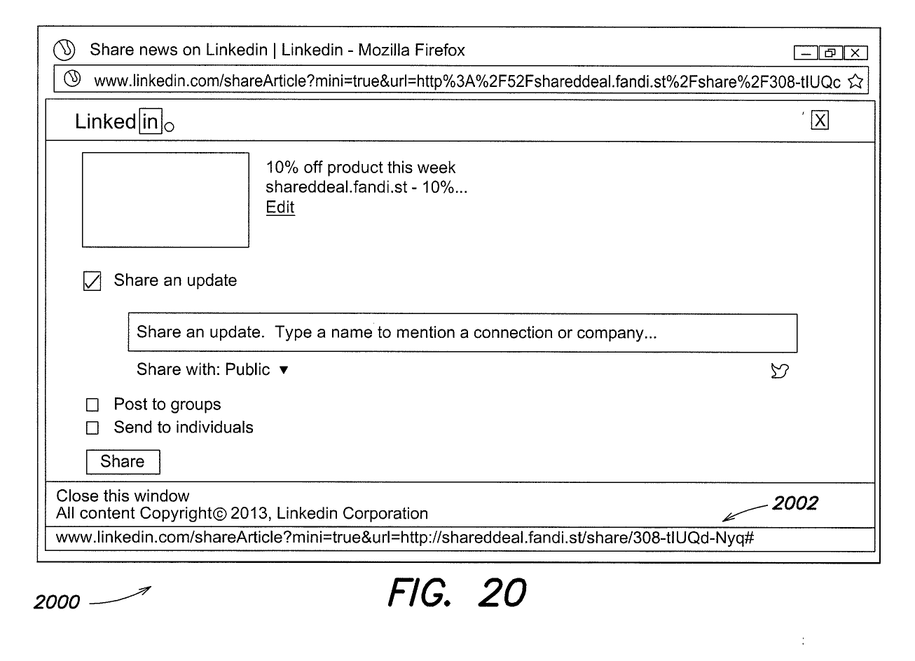

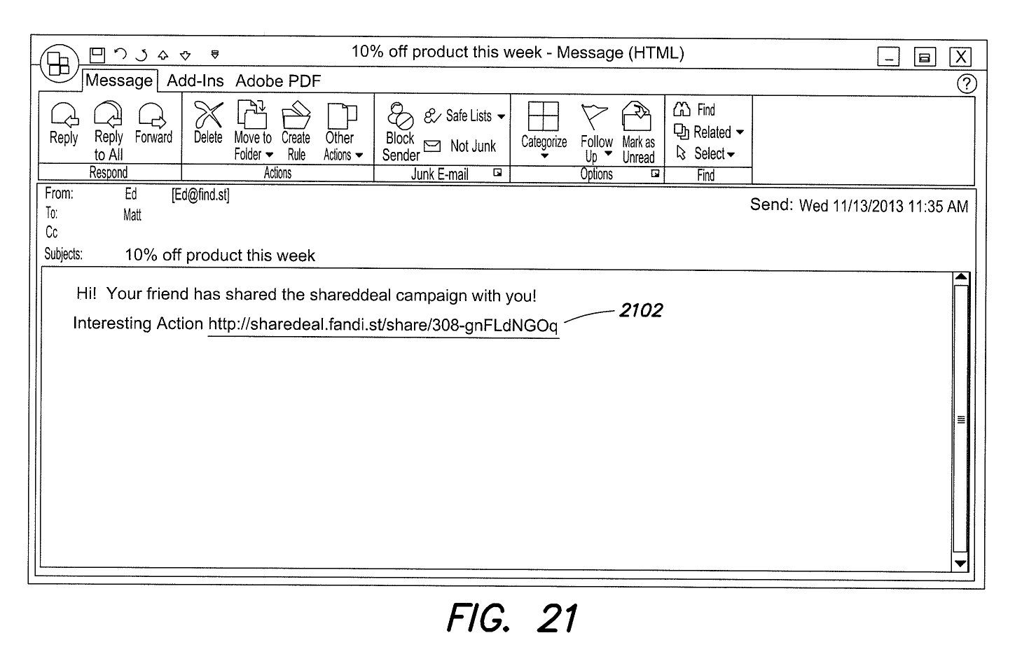

Returning to FIG. 15, digital object delivery can occur via post to a social media site (e.g., via selection of 1502, 1504, 1508, and 1510, among other options). Shown in FIG. 18 is an example user interface 1800 displayed responsive to selection of 1504. Shown in FIG. 19 is an example user interface 1900 displayed responsive to selection of 1510. Shown in FIG. 20 is an example user interface 2000 displayed responsive to selection of 1508. Shown in FIG. 21 is an example message 2100 generated through selection of 1506. At 1802, 1902, 2002, and 2102 respectively, unique identifying information is incorporated into each object campaign domain URL, such that upon selection interaction information can be captured, for example, as a user opens the campaign domain. The interaction information can be context specific (e.g., FACEBOOK, TWITTER, e-mail, etc.), reflecting the source of the information based on the unique identifier. Once received, the interaction information can be associated by the system with a container tag for the respective campaign including any respective media outlet information.

As discussed above, the system is configured to capture information throughout each user's journey, including any interaction with a promotion, trackable digital object, and enterprise web-site. The system enables individuals to become mini-affiliates and/or advocated of specific enterprises, products, etc. By capturing user journey information, which can include transaction based information (e.g., specific purchase information including price), each user interaction can be assigned an accurate value, and each user's influence can be accurately valued.

According to some embodiments, the system provides user interfaces for accessing and analyzing information relevant to campaigns. The information can be provided to the administrator of an external site. The system can be configured to limit the information provided based on, for example, the interactions that target and/or are associated with the external site. According to one embodiment, enterprise users are provided access to information dashboards for viewing user interaction and/or influence information. According to some embodiments, the dashboard interfaces provides aggregation of information across sharing methods (e.g., FACEBOOK, TWITTER, e-mail, etc.). The dashboard interfaces are configured to provide action able information user interactions and/or respective users influence.

FIG. 22 illustrates an example user interface showing a dashboard display 2200. According to one embodiment, the dashboard provides summary information on an accessed campaign or in other embodiments, campaigns. At 2202, information on the campaign is separated into system based information and at 2204 campaign statistics information. Although in other embodiments the displayed can be organized differently and/or include additional statistics, fewer statistics, and/or group information into broader categories.

The dashboard display 2200 can be configured to include navigation links to access different information, management features/functions, among other examples. At 2206 is a link display for accessing different features of the systems back-end analytic and reward functions. According to some embodiments, the dashboard provides system information as a first default display. In one example, the system information for the campaign can include any one or more of: campaign status (e.g., at 2210); active sharing methods (e.g., at 2212); total goals (e.g., actions on which the campaign manager is providing incentives) (e.g., at 2214); active goals (e.g., at 2216); total email vouchers (e.g., rewards delivered for meeting a goal) (e.g., at 2218); available vouchers (e.g., at 2220); vouchers sent (e.g., at 2222); vouchers redeemed; and admin e-mail (e.g., at 2224).

Campaign statistics a display in user interface a 2200 can include any one or more of: total users (e.g., at 2230); total shares (e.g., at 2232); total clicks (e.g., at 2234); total referrals (e.g., at 2236); total sales (e.g., at 2238); users to share % (e.g., at 2240); share to click % (e.g., at 2242); click to sign up % (e.g., at 2244); and click to sales % (e.g., at 2246). The admin user for the dashboard display (e.g., an enterprise user who administers the promotion web-site) can also define additional metrics from the available data, which can be displayed in user interface 2200. For example, the admin user can access settings within the menu at 2206 to define new metrics, modify how data is used to calculate the displayed metrics, among other options. The admin user can also configure the display 2210 itself. For example, the admin user can change the appearance and/or display organization of the dashboard via appearance functions (e.g., at 2252).

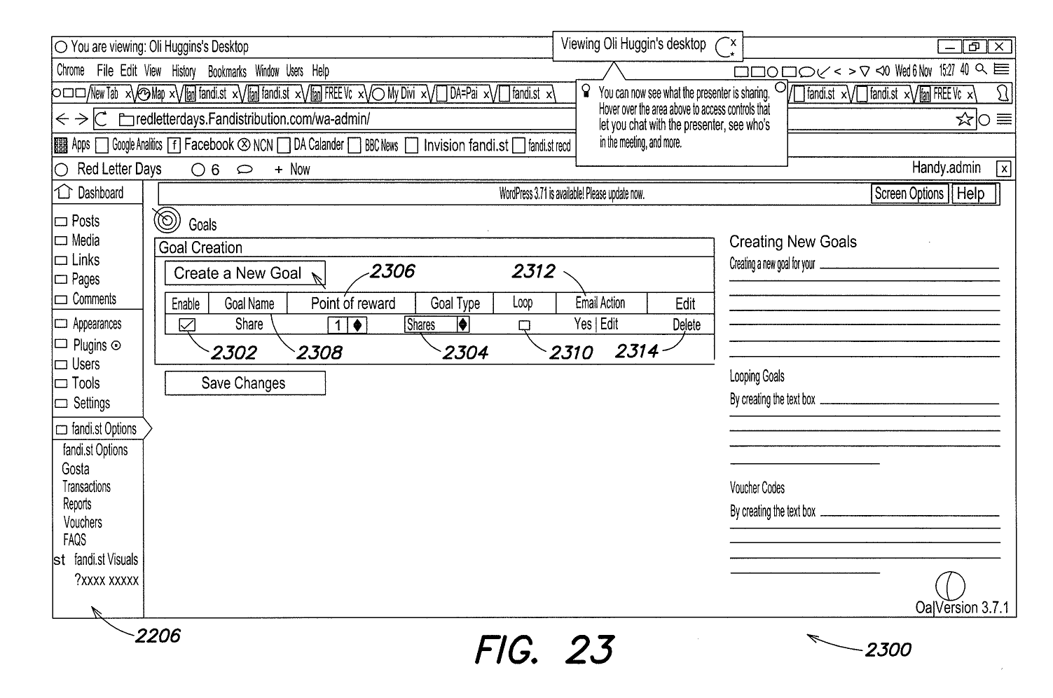

According to some embodiments, each campaign can be associated with one or more goals. The goals can be created by an admin user, and can target specific activity by individual users on which to provide incentives. In one example, functions for creating goals can be accessed via selection of options (e.g., at 2254). FIG. 23 illustrates an example user interface 2300 for creating goals associated with a campaign. Existing goals can be enabled or disabled via selection of 2302. In one example, a goal can specific a goal type (e.g., shares, leads, referrals, sales, likes, comments, etc.) associated with a respective campaign. At 2304, the user interface 2300 can be configured to display a drop down menu for selecting a goal type. In other embodiments, the admin user can type in a desired goal type. In some embodiments, desired goal types can be limited to information defined in the universal variable specification.

The user can also specify a threshold for satisfying the goal. For example, at 2306 the user can select from a drop down menu how many times a goal type must be achieved in order to earn an associated award. Each goal can include a goal name (e.g., at 2308). In some embodiment, a goal can be earned multiple times by individual users. For example, the admin user can specify whether a goal is a one-time award or can be earned every time that the goal is satisfied. At 2310, the loop setting can be activated for goals that are awarded each time a goal type threshold is met. Delivery methods can be specified in user interface 2300, for example, at 2312 “E-mail Action.” Existing goal can be removed as well as disabled. For example, selection of “Delete” at 2314 will delete a selected goal.

According to one embodiment, rewards delivered via e-mail can be customized to include any text and/or imagery the admin user desires. In some examples, the admin user can include unique voucher codes by copying and pasting object code into the e-mail for delivery. Unique voucher codes can facilitate tracking of redemption, and insure that codes are only used once. Multiple goals can be defined for each campaign. Additionally multiple campaigns can share various goals. According to one embodiment, a dashboard display (e.g., 2200 and 2300) can be configured to display information across multiple campaigns and multiple defined goals. For example, the admin user can create additional goal via selection of 2316 “Create a New Goal.”

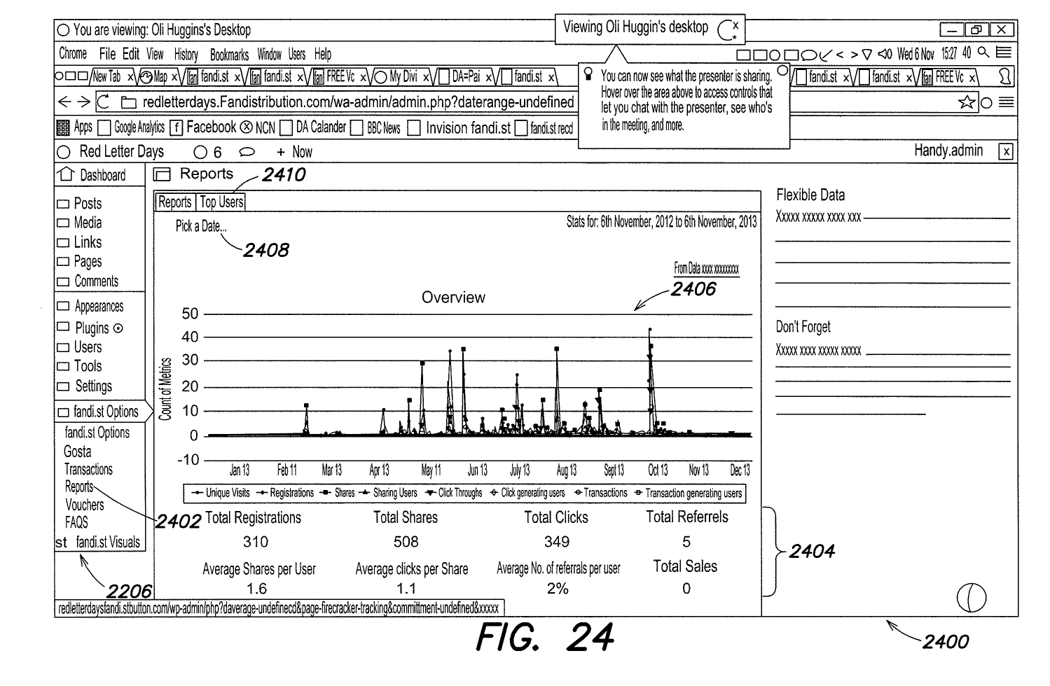

The user interfaces accessible through the dashboard can also include reporting displays. Shown in FIG. 24 is an example user interface 2400 for displaying graphical reporting information. The reporting interface can be accessed via selection of 2402 in navigation menu 2206. The user interface 2400 can provide graphical information on information associated with a campaign. For example, the 2400 can include information on any one or more of: total registrations; total shares; total clicks; total referrals; average shares per user; average clicks per share; average no. of referrals per user; total sales (e.g., at 2404). Any information displayed can also be rendered graphically (e.g., at 2406). According to some embodiments, the reported information can be filter based on an input date and/or date range (e.g., at 2408. Additionally, report information can be displayed on top users via selection of 2410. In addition to metric based goal types, in some examples becoming a top user can be a goal type that is rewarded via a voucher or other award.

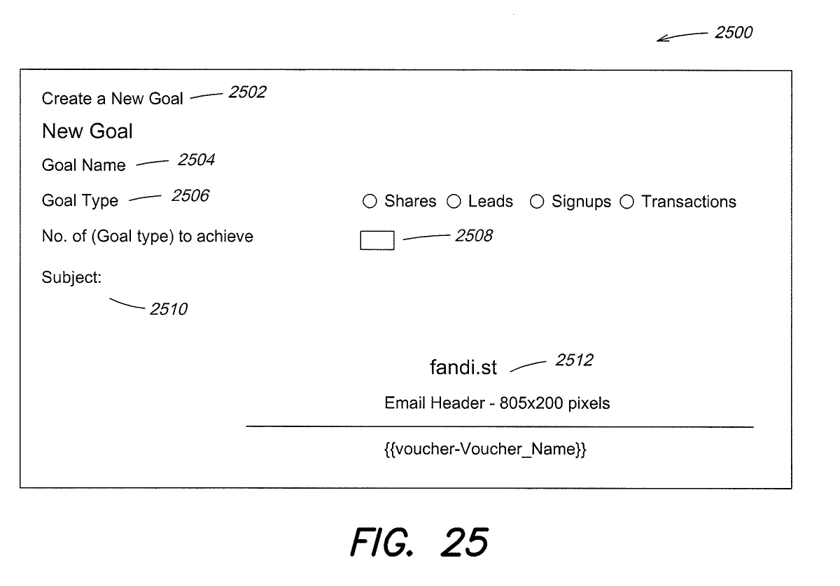

Shown in FIG. 25 is an example user interface 2500 for creating new goals. According to one embodiment, a user can access campaign management tools to create new goals (e.g., at 2502). The user can supply a goal name via text (e.g., at 2504) or other input. In some examples, the user interface presents pre-defined goal options to the user for selection (e.g., at 2506). In other embodiments, the system can provide the user the opportunity to define their goals, for example, the user can define a goal based on metrics tracked from the campaign. Once a goal has been selected, the user can set a threshold for a number of times the goal must be achieved to receive a reward (e.g., at 2508). In some embodiments, goal can be tied directly to rewards during creation. In one example, the user can define vouchers, which the system automatically transmits upon a user meeting a goal. At 2510, the user can defined a subject line for their voucher and the details of the voucher itself can also be configured by editing a voucher template at 2512. In other examples, the user can upload customer vouchers, images, etc., for automatic delivery.

According to another aspect, various systems and methods for managing trackable digital objects can be described with respect to logical organization of the features and functions provided by the logical elements of the system. The following description with respect to the logical elements is provided to illustrated features and functions of various embodiments. The various embodiments are not intended to be exclusive unless specifically stated, and any function or feature discussed with respect with logical elements can be implemented in the various component of the systems discussed above.

### Logical Environment Examples and Elements

According to one embodiment, a system for managing trackable digital objects can include a mass distribution component. The mass distribution component can be configured to host a master domain for accessing campaign specific web-presences (e.g., URLs). In one example, the master domain encompasses “fandi.st.” In additional embodiments, the system can include multiple master domains, and information can be shared, aggregated, and/or filtered between and within such master domains. In one example, the master domain and computer system(s) hosting the master domain is configured to provide a self-service, opt-in, peer-to-peer social distribution sharing and tracking service. Individual users can access the hosting system(s) to register, view campaigns, create campaigns, and share that content throughout any digital connection regardless of the platform used to connect.

In one embodiment, the mass distribution component is configured to rapidly deploy digital content, campaigns and offers (via system hosted URLs (e.g., xxx.fandi.st) into users' social networks and email systems. The mass distribution component captures influence and engagement information across the delivery platforms (e.g., FACEBOOK, TWITTER, e-mail, etc.) in real-time, measured on shares, clicks, views, and transactions by downstream individuals. According to one embodiment, the mass distribution component can be made available as a free service to facilitate rapid, global roll-out and deployment.

According to one embodiment, the mass distribution component can include a marketing automation component configured to establish customer goals, rewards, and incentives which can be distributed by individuals and tracked for effect over any communication platform. The marketing automation component can include template routines configured to optimize selectable key performance indicators (“KPI”) (e.g., shares, clicks, transactions, actions etc.) and conversion rates for the desired KPI (e.g., customer acquisitions, sales, new subscribers, etc.).

According to another embodiment, the mass distribution component can also include a data acquisition component configured to capture and manage multiple data sets from user behavior. The data can be captured both on site (e.g., via hosted URLs) and off-site (e.g., system external URLs). According to one embodiment, the system generates digital objects with embedded dynamic URLs that enable tagging of user activity on external sites that is reported back to the system. In one example, share buttons are incorporated into campaigns for promoting specific actions, products, service, etc. Execution of “share” functions in those objects generates trackable information reported to the system. Even commentary made on social platforms can be configured to trigger tagging and reporting back to the system (for example, via dynamic URL assignment. In some embodiment, external sites can be provided with tracking scripts or source code for capturing attribution information or the information specifying the details of respective user journeys from contact with an originating user to actions, transactions, etc., taken on external sites. Examples of tracking scripts/tags, which can be distributed to administrators of external sites, are described in greater detail below:

Tracking Script Example

In some embodiments, a user desiring to capture information can copy and paste this Script onto all of the pages of a web site within the head tags. This will enable the system to show you what impact your Campaigns are having on your site. NOTE: You must add this Script to your site if you wish to track Transactions.

<script type=‘text/javascript’>
(function( ) {
var fd = document.createElement(‘script’); fd.type = ‘text/javascript’;
fd.async = true;
fd.src = (‘https:’ == document.location.protocol ? ‘https://’ : ‘http://’) +
‘cdn.fandi.st/FD-343-01.js’;
var s = document.getElementsByTagName(‘script’)[0];
s.parentNode.insertBefore(fd, s);
})( );
</script>

### Example

### Tag: Transactions

In some embodiments, to attribute Transactions on a given web-site to specific Campaigns on the system, the follow tag can be incorporated into a Transaction confirmation page. An administer can follow the JSON object specification and populate the values from your system. Debug console can be provided to run live tests on a development environment. The debugger will open a window below that will give a live response from the system validating an implementation.

window.universal_variable = {
page: {
category: “Confirmation”
},
transaction: {
order_id: “HSS012546”,
currency: “GBP”,
total: 100.00
},
debug: true
};

Run Live Test

Integration of the tracking script can be as simple as a copy and paste operation into the web page's source code. In further embodiments, specifications for customized data objects can also be provided to external site administrators. An example specification for a transaction object follows—which captures information on the external site as a transaction object for relevant activity (e.g., sale, purchase, rental, etc.). The transaction can then be reported to the system for attribution and analysis.

Transaction

The Transaction object can describe a completed purchase, and in some embodiments, can be displayed on a confirmation or receipt page. At least some transaction objection properties are shown in Table I.

TABLE I

| Property | JSON key | Type | Description |
|---|---|---|---|
| Transaction | order_id | String | A unique ID for this transaction. |
| ID | | | |
| Transaction | returning | Boolean | False if this is the first time a user has been |
| Returning | | | served this Transaction, i.e. it has just happened. |
| Status | | | True if this Transaction has happened some time |
| | | | ago and its details are being reviewed. For |
| | | | example, the Transaction object on a page served |
| | | | to a user when they have just completed a |
| | | | purchase should read ‘False’, but if the user |
| | | | returns to this page, for example when clicking a |
| | | | link sent in a confirmation email, it should read |
| | | | ‘True’. |
| Transaction | currency | String | Mandatory. The ISO 4217 code for the currency |
| Currency | | | this transaction's costs are denominated in. |
| Transaction | payment_type | String | Payment method, e.g. ‘Visa’, ‘PayPal’, ‘Voucher’. |
| Payment | | | |
| Type | | | |
| Transaction | subtotal | Number | The transaction amount, excluding shipping or |
| Price | | | discounts. |
| Transaction | subtotal_include_tax | Boolean | Indicates whether Transaction Price includes tax. |
| Includes Tax | | | |
| Transaction | voucher | String | Voucher code entered. |
| Voucher | | | |
| Code | | | |
| Transaction | voucher_discount | Number | Total amount of discount due to the voucher code |
| Voucher | | | entered. |
| Discount | | | |
| Transaction | tax | Number | The amount of tax payable for this transaction. |
| Tax | | | |
| Transaction | shipping_cost | Number | The amount of shipping cost payable for this |
| Shipping | | | transaction. |
| Cost | | | |
| Transaction | shipping_method | String | Delivery method selected for this transaction. |
| Shipping | | | |
| Method | | | |
| Transaction | total | Number | Mandatory. The total cost of this transaction, |
| Total | | | including tax, shipping and discounts. |
| Transaction | delivery | Address | Delivery address for this transaction. |
| Delivery | | object | |
| Address | | | |
| Transaction | billing | Address | Billing address for this transaction. |
| Billing | | object | |
| Address | | | |
| Basket Items | line_items | Array of | The items (and their quantities) present in the |
| | | LineItem | basket. One LineItem per distinct product. |
| | | objects | |

Example Transaction Object:

window.universal_variable = {

“transaction”: {

“order_id”: “WEB123456”,
“currency”: “GBP”,
“subtotal”: 123.00,
“subtotal_include_tax”: true,
“voucher”: “MYVOUCHER”,
“voucher_discount”: 0.00,
“tax”: 10.00,
“shipping_cost”: 1.00,
“shipping_method”: “Standard Mail”,
“total”: 130.00,
“delivery”: {

“name”: “Full Name”,
“address”: “234 High Street”,
“city”: “London”,
“state”: “London”,
“postcode”: “SW1 1AB”,
“country”: “GB”,

},
“billing”: {

“name”: “Full Name”,
“address”: “234 High Street”,
“city”: “London”,
“state”: “London”,
“postcode”: “SW1 1AB”,
“country”: “GB”,

},
“line_items”: [LineItem, LineItem, LineItem, ...]

}

}

According to one embodiment, the tagging information enables the system to associate that data to the individuals who created it, via their actions and behavior. In one example, the data gathering and attribution allows marketing officers to identify and/or follow a user journey from where the user entered a site, to an event on-site (and any/all points in between—which can include how long the individual viewed a page on the site, what pages the individual accessed on the site, what media platform did the user engage before accessing the site, who referred that individual, etc.). By providing information on the entire user journey marketing officers can use the system to accurately assess effectiveness of different marketing initiatives and channels.

In some embodiments, the data acquisition component is configured to gather and record other data sets, which enable generation of a digital fingerprint for each individual/user. In one example, a digital fingerprint can be based on any one or more of: user device identifier, IP address, browser, browser plug-ins, etc. In further examples, the digital fingerprint can also include information on browser version, position information, current sign-ons, active log-ins, etc. Based on this information, the system can generate a unique identifier for users and associate data captured from disparate systems, platforms, web sites, etc., to a specific user who generated or is responsible for the generation of the user activity. According to one embodiment, digital fingerprinting enables the system and/or data acquisition component to track user behavior and user activity across multiple sites without the use of controversial third-party cookies. In some embodiments, the data acquisition component is configured to capture data on user behavior according to consistent and standardized data models. Some examples of consistent data models are described in the known “Universal Variable Specification.” Other data set examples can be based on combinations of environment data, social data, and activity information.

Various embodiments are configured to track respective users' behavior across an entire customer journey. In some embodiments, data privacy and user consent is required to ensure privacy concerns are met. In one example, privacy settings can be managed by the data acquisition component based on opt-in controls—where users who wish to value their influence are required to opt-in (e.g., register with the system) in order to have their behavioral data tracked and their influence measured.

According to one embodiment, the data capture component can be configured to capture and/or receive data based on user defined triggers. In some embodiments, page tagging processes are executed to capture information responsive to the user defined triggers. The tagging data (i.e. information on individuals and their behavior) can be captured and communicated to the system. In other examples, the data capture component can be configured to capture data coming on-site (e.g., accessing system hosted pages) from external sources, including social networks, affiliate sites, calls to action offline, data bases (i.e. e-mail), and search traffic among other examples.

According to other embodiments, data tracking can also be executed using dynamic URLs generated by the system for inclusion into trackable digital objects. In one example, generation of a trackable digital object includes selection of sharing executables to include in the object (e.g., sharing buttons). In one example, each sharing button is configured to employ dynamic URLs to enable tracking to occur on downstream peer-to-peer interactions. Thus, sharing of a digital object becomes a data capture and delivery event upon execution of the sharing button. As a user's social network shares the digital object (e.g., to their own connections, and their connections share the digital object, and so on . . . ) each share is captured and attributed to the originating user(s). In some embodiments, such shares can also be attributed to the intermediary users. In one example, use of the sharing executable, generates a post for a user's social media wall with the dynamic url embedded, such that subsequent access to the dynamic url provides information to system on user interactions with attribution information.

According to one aspect, the system for managing trackable digital objects provides unique peer-to-peer marketing opportunities. The self service tools can be used at any entry level from enterprise data attribution and reporting to individual plug and play environments. Individuals can be advocates and/or mini-affiliates of their favorite enterprises or brand. Such advocacy can be directly awarded based on the individual's value. In some examples, individual value can be based directly on transactions, making scoring accurate and comparable. Enterprise users can benefit significantly from such activity, deriving new users, capturing data on user behavior, user influence, and user value with an accuracy that has never before been possible.

According to one embodiment, the system can be implemented as a Software as a Service (“SaaS”) toolset. The SaaS toolset can be configured to mimic existing social media platform in terms of content generation and distribution. In some examples, the toolset assists any individual in the design, implementation, and distribution of a call to action (e.g., a “campaign”). The system incorporates sharing executables into the trackable digital object that results from campaign generation. Each sharing executable can be configured to distribute the object via respective social channels, so that the campaign originator/sharer can drive traffic to any desired location. The SaaS toolset can be configured to provide a reporting dashboard for user information describing individuals and/or users who have interacted with their campaign. In some examples, the user information includes what media channel was accessed, and information on how respective users behaved in response to their call to action.

This resulting behavior is attributable back to the individual who initiated the campaign and, because of this attribution, a system of rewards and incentives can be implemented to encourage virality via distribution across personal networks and increased responsiveness to calls to action. According to one embodiment, the system is configured to aggregate personal management of social networks into a SaaS toolset, putting control and management of distribution into the hand of individual users. According to one aspect, providing a SaaS toolset and making the campaign build process simple and intuitive enables even novice users to register and define a campaign in under five minutes. Limiting build and launch time enhances the capability and penetration of viral marketing. Additionally, reporting in real time to the originating users on their peer group's responses provides a revolution in direct to consumer sales, peer-to-peer market automation, and marketing intelligence.

Each individual user can access the system to define campaigns/desired actions, and receive in real time data reporting and attribution of their peers' activity, thereby providing a feedback loop and a compulsive consumer experience, with users checking the frequency of clicks and shares on their socially distributed messages to their own networks which are updated in real time.

According to some embodiments, the system can provide marketing automation tools. The marketing automation tools are configured to the public a platform to promote any web based object that can be linked to via a URL. Each object can then be tracked to measure users' behavior (e.g., shares, clicks, views, transactions, etc) which can include tracking of user defined actions. According to one embodiment, user defined actions are captured by the system as event objects. In one example, the universal variable specification defined elements of an event object that can be recorded and communicated to the system. The system can be configured to report on any tracked information and/or user. In some embodiments, information can be captured and reported as user journeys and interactions. The user journey can begin with the first view of a trackable digital object, access to the system hosted URL, and continue at system external sites (e.g., using tracking scripts) until a desired action is achieved (e.g., sale). The trackable digital objects can include any user defined message, media, content, or other information containable in a web based environment. The tracking scripts and/or URLs incorporated in the trackable digital objects enable capture of all related user behavior data, such as pageviews, sharing, clicks, unique visits, which can be displayed with other related data in a user dashboard. The user dashboard can be configured to display the behavioral and related data, and present the user with an interface to manage and incentivize specific user behavior. For example, goals can be defined to promote specific user behavior, where for example, shares can trigger a reward to a user who achieves a threshold number of shares. Any user behavior can be optimized through such incentives. Further, analysis of the user behavior yield significant insight as to which users most effectively convey and/or influence behavior. In some examples, the SaaS toolkit is configured for reward definition and management. For example, an enterprise can define a voucher program. The voucher program can specify a reward (e.g., coupon, discount, cash, etc.) delivered to a user upon a triggering event. The voucher program can be activated or de-activated through management functions. One or more triggering events can be defined until, for example, a set number of vouchers are communicated.

According to another embodiment, the SaaS toolset is configured to provide a personal communications tool that allows users to conduct cross social platform communication including sharing of objects or services, via embedded dynamic URL links. In one embodiment, the system enables uses of any digital communication channel. The system and/or the SaaS toolkit can be configured to uniquely track user sharing across networks via links (e.g., dynamic URLs with unique identifiers), as opposed to conventional systems that require centralized/singular points of sharing or discovery (for example FACEBOOK.com). Trackable digital objects can also be embedded in a blog, TUMBLR, FACEBOOK, e-mail or a tweet, and all data & activities around each embedded object are captured for display in the user dashboard. In some embodiments, the user dashboard includes metrics to show a measure of interest (clicks), adoption (transactions), and virality (shares) in order to report demand across different markets sectors products and services.

According to another aspect, data privacy and data security are implemented to protect personal identifiable data. According to one embodiment, track data sets are stored and split into anonymous non-attributable data, and personal attributable data. Personally attributable data can be stored into a secure personal data locker within the system. In some embodiments, the system is configured to limit access to personally identifiable data, such that it is owned and controlled by the user. In further embodiments, the system can access personal attributable data based on user permission. According to another embodiment, non-attributable data is available for data interrogation by system, clients, and/or system users.

According to various embodiments, the system can be delivered as a user permission based vendor relationship product. In one example, putting control of user data into the hands of the users themselves via permission control, solve many existing issues with data collection, privacy, and specifically consumer concern over third party cookies and data control.

As discussed, the system can be configured to enable clients (e.g., enterprises) to identify advocates (e.g., individual users) and track the influence of their advocates. In some embodiments, the clients can track that influence geographically, enabling them to literally map their influence. In some examples, the geographic influence information can be used to target advocates with a high influence over a key area to promote proximity based promotions. In one embodiment, location can be identified by IP Geoloation and/or JavaScript Geolocation. In another, address detail can be captured (e.g., via Universal Variable formatted information). In further examples, geolocation information can be obtained from a device GPS and/or browser lookup information. In some embodiments, the reporting information provided on the system enables filtering the user data based on location allowing direct contact those users to introduce to a new promotion. Further, new promotions can be created based on previous promotions, within location filtering the system can target specific users having influence in specific locations to introduce to the new promotion.

In some embodiments, the system is configured to track all types of influence behavior. In some examples, the client can define on the system what type of influence provides the greatest value, enabling the client to use the system to segment their database of users by their ability to refer on any one or more of: transactions, clicks, quotes and sign-ups, among other behavior types. In some examples, influencer types can also be used, where the influencer types are based on environmental and/or relational data captured by the system. For example, relational data showing the attributed effects of third party user behavior that successfully influence and affect client defined outcomes of user behavior can be used. Additionally, relational data can be used to rank users by their actions that have successful client defined outcomes. As discussed, the system can specifically reward influencer outcomes via goals.

In one example, environmental types used by the system can include: Sector based classification (Tech influencer or Fashion), Location based classification (Bands in Germany), and can also include information on volume drivers for virality items.

According to other implementations, the system can be further configured to provide any one or more of the following features: enable clients with an interface to design and build a recommendation web application that is configured to facilitate the sharing of a promotion by advocates; and enable clients to compare and contrast the results of their campaigns, so they can optimize for their target audience and identify, for example, which social media platform has been most effective for a particular campaign.

According to one embodiment, the system is configured into at least three main data collection and attribution tools for client deployment with the following elements and functions:
collation component for collating data from external traffic to client sites. The collation component can be configured to employ dynamic URLs that integrate social, user, and product data from third party sites, social networks and emails, allowing clients to integrate data from all their incoming third party site traffic URLs. That data can be integrated into system based marketing routines, with further tracking by system generated/provided dynamic URLs containing client, campaign, product, user and destination page;
offsite distribution component configured to distribute offers and content offsite (e.g., external to the system). The component is configured to enable the building/generation of offers and content and further to embedded social sharing buttons (e.g., at 1502-1510 which enable page tagging function to capture data) allowing clients to enable data capture from social network sharing of offers and content off site with attribution to an originating user;
on-site social distribution configured to distribute offers, content, and/or campaigns on the system by system users. Page tagging functions are implemented to capture user interaction information, attribute that information to an originating user, intermediate users, etc. The aggregated information can be viewed by system clients to track such users on-site and analyze their activity, which can occur in conjunction with user information capture on third party sites.

According to another embodiment, the system is configured to capture information from multiple sources. For example, the system can capture information from any one or more of: users interacting with routines; offers and products; interaction with other users; tracking off site traffic (e.g., on clients' sites and on site developed content off site); data obtains from page tagging; and event enabled data collection and tagging, among other options. The data can be collected when people engage with the content (via URLs) that was generated from the system without regard to the social platform the user engages with leading to the content. The system generates marketing intelligence designed to optimize client defined outcomes (e.g., drive digital transactions, e-commerce and new customer acquisition) based on the platform agnostic data.

According to one embodiment, the system can include market intelligence functions, that when executed collect and collate at least four distinctive data sets. In some examples, the data sets are configured to resolve on a client defined outcome (i.e., related captured information to a specified outcome). In some embodiments, the accumulated data can be organized into a hierarchy. The hierarchy can include information on a client, product, campaign, routine, and a user, stored, for example, as attribute-value pairs. The hierarchical organization enables interrogation of data on each of these categories. As discussed, the data can be organized such that any interrogation ultimately resolves in client defined outcomes.

In some embodiments, the system captures and organizes the four data sets as follows:
user behavior objects which can include user behavior defined by actions, page views, shares, clicks, and transactions. In some examples, data from obtained user behavior can be used to trigger marketing automation routines. In one example, the system monitors calls to actions based on executing the marketing routines, which can be delivered via emails, site pop ups, or similar methods.
environmental data object, which can be collected through page tagging functions (e.g., tagging scripts and embedded tags on pages). In one example, the environmental data objects stored information on trackable digital objects and actions defined by web pages functions (e.g., previous pages visited, check out page, transaction value, page and object dwell time, among other options).
fingerprint objects, which store information on a user's digital “fingerprint.” In one example, the user fingerprint can be defined by information on the browser executing on the user system, plugins, device information, IP address, among other options. In some embodiments, the digital fingerprint information can be used to generate a unique id for a user and the unique id used to attribute, for example, off site activity to a specific user.
peer-to-peer data object, which can include relational data showing the attributed effects of third party user behavior that successfully influence and affect client defined outcomes of user behavior (e.g., lead to a desired action and/or outcome being achieved). In one example, the system employs the relational data to rank users by their actions that have successful client defined outcomes.

According to some embodiments, the system is configured to capture Internet Browser events based on browsers interacting with web pages, and to associate the events to an individual user that instigated the engagement. In one example, the associations made by the system can be based on individual engagement with trackable digital objects created and/or shared via the system. In one example, values/information from a visited web page are made available via javascript executed by the browser, and actions of the individual on the particular page can be tracked by the system during the individual's engagement. In one example, the actions and activity the individual performs on the web page are captured and organized into user behavior data objects.

Trackable digital objects can be generated on the system in any format, and can include user defined message, media, content, or other information containable in a web-based environment. In one embodiment, each trackable digital object can include dynamic URLs that capture individual user and behavior data, which the system associates with data derived from user-instigated events, user journeys/paths and the data from third party users re-sharing and clicking on these trackable objects. In some embodiments, each dynamic url can include a unique sharing identifier, such that the system can associate information with an originating user or event. In one embodiment, the user originated behavioral data resulting from those interactions is captured, for example, when a web based document loads, triggering any javascript. The system can be configured to read any pre-defined variables (e.g., data objects identified in the Universal Variable Specification) within the web based document. In addition to user behavior information, environmental information can also be captured. An example of captured data includes information capture from the browser: “user-agent”: “Mozilla/5.0 (Macintosh; Intel Mac OS X 10_{—}8_{—}5) AppleWebKit/537.36 (KHTML, like Gecko) Chrome/30.0.1599.69 Safari/537.36”, “x-forwarded-for”: “91.229.127.72”, “accept”: “image/webp,*/*;q=0.8”, “x-forwarded-proto”: “http”, “accept-language”: “en-US,en;q=0.8”, “host”: “162.13.24.171”, “referrer”: “http://jon.fandi.st/”, “connection”: “keep-alive”, “x-forwarded-port”: “80”, “accept-encoding”: and “gzip,deflate,sdch”, cookies set against domain. Device specific information can also be captured and incorporated into environmental data.

The combined behavioral and environmental data set is centrally tracked by the system. In some embodiments, communication to the central server is executed asynchronously over standard http network traffic triggered when a respective page is loaded. The system can be configured to generate reports on the combined data in various dimensions; including any one or more of: location (geographical), time-based events, links originating from web based communication systems (e.g., FACEBOOK, TWITTER, e-mail and other web-based communication systems), and individuals influence on their peers. In one example, influence is measured on the relative values of user-defined actions resulting in a desired outcome on the users' behavior.

According to some embodiments, the system can provide unique data sets as a consumable product. The system can be configured to provide unique combinations of standardized social and environment data. In addition, enterprises/owners are able to interrogate the entire data set (depending on permissions) relating to the users social and relational data, environmental data, and the events that trigger pre-defined goals. The data trail can be viewed and appreciated by the enterprise as a entire user journey from an initial contact through to any defined event/outcome. The user journey can be captured from social media, include any sign up, pre-defined event (display a quote or pricing page), and used custom APIs to interrogate offline data stores such as insurance company product databases.

In one example, data can be organized based on a user type:
Prospect—unknown (e.g., people likely to take a desired action)
Suspect—signup with email (e.g., possible customer whose intent is unknown)
Lead—Web based Attribution onto data store (e.g., referred individual)
Sale—Online/Offline Attribution data store (e.g., individual executing a transaction)

In some embodiments, the data can be organized into data objects based on the nature of the data being captured. For example, the data set can define and provide information on the relationships between: People (e.g., individuals being tracked), Products (e.g., enterprise products, services, opportunities being offered to consumers), Brands (e.g., enterprise brand identifiers), Environment (e.g., social platform, web site), Behavior (e.g., sign up new users, 3U register, share, like, purchase, etc), People's social networks and related users (e.g., identifying contacts and intermediate users to associate with a campaign originator or distributor). In one example, the behavior data reflects any analysis information on a user A who generated a campaign, shared the campaign with their FACEBOOK contacts, where user B (a member of user A's contacts) elected to view the campaign. The tracked information can include a product that is the subject of the campaign. Further, any contact accessing the digital object posted to user A's FACEBOOK page/wall can be identified and track by the system. Subsequent shares by those users can likewise trigger data capture.

According to some embodiments, the data acquisition component can be configured to execute and/or receive information responsive to owner defined events. Owner defined events can be based on users activity, including, for example, sharing of a trackable digital object, viewing a web site, registering, etc. For example, the capture of behavior information can take place responsive to a purchase, triggering data collection and attribution. The system can then associate all information attributed to respective users. In some embodiments, the system can incorporate machine learning approaches and/or heuristics to derive patterns and/or relationships around user behavior data.

As discussed, data capture can be executed using page tagging functions as web pages load. In some embodiments, the system employs single container tag tracking beacons to capture and report data. For example, the system's tag tracking beacon is configured to track users off site, trigger data collection/attribution, and facilitate integration with additional library tags (e.g., GOOGLE ANALTICS). Additionally, the system can generate and include dynamic URLs in trackable digital objects, where the dynamic URLs are configured to allow the system to analyze and attribute events and actions to individual users, including uniquely identifying interactions between users. In one example, each dynamic url is unique, enabling the system to track and attribute each interaction based on client, campaign, originating user, intermediate user, and a destination url, among other options. In addition, the system can also provide sharing buttons as part of trackable digital object creation. The sharing buttons can be configured to embed the system generated dynamic URLs into whatever object is being shared (e.g., YOUTUBE video, blog page/entry, etc.).

### Example Applications and Example Benefits

According to another aspect, the system for managing trackable digital objects can be implemented in virtual any environment to track, deliver, and share any type of digital object. According to some implementations, enterprise clients have focus on member-get-member activity (e.g., where an advocate user recommends to their friend a registration opportunity through a trackable digital object), or incentivized peer-to-peer selling campaigns (e.g. where an advocate recommends a product or brand through a trackable digital object). Although there is significant value in those actions, the systems toolset offers ever more sophisticated applications for enterprise clients. Described below are some examples of user journeys to provide insight into the range of potential applications that the combined toolset can deliver. The examples provide are meant to be illustrating and not limiting to the specific implementation examples provided.

In one embodiment, the system can drive increased insurance policy sales for commercial insurance brokers. Automobile insurance companies supply coverage for many hospital trusts and Parish Councils. The challenge in such markets includes identifying new clients among the many thousands of potential customers in a sector group that is very difficult to penetrate. In some executions, the system enabled these provides to concentrate their sales efforts on clients who responded to digital campaigns by sharing product information with other prospective customers in their affinity group. In one execution, the result was a 300% increase in policy sales as well as increased brand awareness.

Conventionally, US insurance brokers and agents purchase names and addresses of individuals whom they can approach to sell insurance products. These same names are sold to many agencies at the same time. In one embodiment, the system enabled creation of an insurance product, which incorporates leads generation capability into the products' existing functionality to enable respective insurance agents to deploy social media sharing campaigns to identify new, better quality leads through their existing customer base.

In another example, the system can be used to engage a major sports club fan base. With Manchester United, the system is being used to build multiple campaigns to identify the most engaged and influential fans among their 20 million active database of fans. Using the system, Manchester Utd. can then incentivize and reward those influential fans to drive increased commercial activity, by sharing exclusive offers. Example exclusive offers include any one or more of: access to the Man Utd. Direct (e-commerce site), match-day VIP seats, subscriptions to Man Utd. TV channel, subscriptions to Man Utd. Online, fan club membership, and engagement with sponsors (e.g., BWIN, an online gambling company).

Further examples, provide for affiliate marketing: commercial site and pop culture site in combination. For example, sponsors can support multi-media campaign of other enterprises. In one example, system tags and trackable digital objects can be deployed on both sponsor sites and any site for the sponsored activity. The system is configured to match data collected from both sites to individuals identified by their digital fingerprints. The system can thus avoid double counting and provide de-duplication of user behavior activity. For example, the system establishes that the two data sets belong to the same individual without need for cookie other conventional link-tracking methods. The system can uniquely identify visitors, and enable enterprises to offer “special discounted package for fans of sponsored activity” (e.g., via pop-up delivery).

Individual users can be directed to a sign-up pages where he/she completes a desired transaction. Once signed up, the individual can then be offered the chance to share the offer to his/her social networks via a trackable digital object for a further incentive (e.g., Amazon vouchers) in order to drive new subscribers.

In an offline example, a radio station can employ the system to service its on-air calls to action to listeners to sign-up and share to with their networks the songs that they like the best. The listeners displaying the most influence (for example, identified by the system in terms of driving traffic to the radio web-site, and/or downloads of tracks) can be rewarded with, for example, concert tickets, downloads or other engagements.

In another embodiment, the system identifies a media personality's most engaged and influential fans through competitions distributed as trackable digital objects. The competitions feature “money can't buy” prizes (e.g., signed and personally dedicated books) to those fans who drive the most new subscribers to a specified site. Once the most influential fans have been identified by the system, they can be recruited into an exclusive club of super-fans who can then be deployed and incentivized to receive and share offers.

In another example, the system provides alternative revenues streams to existing median channels. For example, a YOUTUBE publisher can employ the system to create competitions to drive visits to the publisher's YOUTUBE sites.

The system also include far reaching implications for individual users. For example, a budding novelist having their new book recommended on, for example, Stephen Fry's 6.4 million strong twitter feed, wherein the tweet is a trackable digital object, can yield significant data on the subsequent twitter users responses leading to e-book subscriptions. The system can track online and offline sales for the recommended book to provide unique insight. In another example, the system enables a teenager to post updates on her social networks and receive real-time feedback on which of her “friends” reacts. In further examples, a blogger wishing to build an email database of subscribers to her blog based on click opt in responses can generate trackable digital objects through the system for sharing over any social media platform.

According to others examples, enterprise clients can derive some unique benefits including any one or more of:
Channel optimization, where the system creates a standardized metric, allowing marketers to judge the return on investment (“ROI”) of separate marketing channels under the same criteria, and thereby optimize activity and spend. Because the system attributes events (e.g., transactions) to the data which leads to them, the system enables the relative value measurement of traffic coming to a site from multiple channels: social networks, affiliate marketing partners, third party emails, and calls to action. Using this information, marketers can make more informed and effective (and potentially lower cost) above the line media buying decisions based on real behavioral and event information.
deliver improved and robust ROI information, for example, where existing digital marketing methods rely heavily on cookies, clicks, likes and other methods of inferring advertising effectiveness. Many of these measurement methods are becoming increasingly discredited—for example, multiple affiliate solutions, non-standardized, ad clicks generated by bots, cookie stuffing, and cookie flushing all distort both data volume and unique data capture events under conventional approaches. The system generates measurable metric that are attributed to users based on their behavior resulting in actual sales from real and unique individuals delivered on a performance related basis—no better measure can exist for marketers.
enterprise change management functions. The system enables optimization of “Above the Line” activity and spend, such that the cost per acquisition of new business can be lowered—potentially significantly. The system and/or toolset yields real-time results enabling rapid responses and therefore, more competitive marketing, sales and product development. Used at scale across an enterprise, the toolset can be a catalyst for major change management activity.
identification of early adopters online to drive mass adoption offline. The well-established “Diffusion of Innovation” theory is a significant driver of marketing techniques for a new product roll-out. Any business that subscribes to this theory will benefit from the system's toolset, as most early adopters are both active in social media, and influential. By engaging and incentivizing early adopters online, an enterprise increases the speed and effectiveness of driving mass adoption off-line.
Anticipate Privacy issues. In one example, the system protects user privacy and data by operating an opt-in environment. Furthermore, the system ensures that personal data is held in a secure personal data store—providing a key step towards an individual-controlled vendor relationship, and can, for example, be used to implement an intelligent agent model.
improved social distribution. Traffic to e-commerce sites can be easily increased through qualified lead generation by leveraging users' personal social networks accessed via permission-based opt control provide by the systems. This approach generates new customers only accessible through users' networks, while also producing cross-platform data and relative values for all users in a client defined campaign data set. The system uses no advertising or unwelcome third-party cookies and incentivizes peer-to-peer activity with rewards given in exchange for successful outcomes and user data history.
tagging enabled sharing functions and buttons onsite. Enterprises can distribute and track content and offers using tag enabled sharing buttons and tracking via persistent and dynamic URL link generation. By implementing these simple tools through the system, an e-commerce site can convert increased traffic to sales directly, and hence reduce the need for SEO and ad word buys. Persistent links allow cross-platform tracking which boosts page views and therefore, returns traffic on links and click through ad revenues, all of which increases reach, data and sales.
a unified data attribution marketing intelligence, which can be based on user behavior, and attributed user journeys. The system is configured to incorporating both online and offline data into attribution models will allow marketers to see the true value in multichannel marketing. Vendors most able to integrate this data can deliver the greatest insights into consumer behavior. It is realized that in various embodiments, there is a large opportunity to connect offline to online activity. The system can uniquely combine mass user tools as described in the offline example, to track real world and/or physical calls to action with reciprocating social behavior, thus allowing real time measurement of offline inputs online.

According to another aspect, conventional marketing approaches fail to deliver an accurate view of customer behavior. For example, companies are seeking a ‘single view of truth’ from confusing and conflicting data sets across multiple channels and devices. Traditional last click affiliate marketing data is inaccurate and prone to fraud and manipulation. Multiple data sources, from search, to CRM, further muddy the data picture, as digital channels, and devices proliferate, and users migrate between them.

Conventionally, there are often up to 20 touch points along a customer's journey from an initial interaction to, for example, a sale (this number can reach into the hundreds if display ad impressions are included), and these touch points can come from a myriad of offline and online channels. The online channels invariably have differing tracking methodologies, with the data from each channel/method, historically being analyzed in isolation, making attribution and measurement extremely difficult and inexact.

It is realized that attribution across channels relies on getting complete data from all channels in one place, and being able to integrate it across channels more accurately, allowing decisions to be based on user behavior and data mining along the user journey, rather than on assumptions, inference and complex algorithms.

According to one embodiment, the solutions provided by the system brings these datasets together in real time to gain rich visualizations of the entire customer journey. The data can be captured under standardized format so that one can compare apples to apples. According to some embodiments, the system's attribution jumps silos to analyze how channels work in different circumstances, and how they work together, and which users have influenced the customer journey and can be attributed to the outcome of the journey. Thus, no assumptions and no inference are required, just analyzing real data from real individuals and their actual behaviors.

Further embodiments, deliver these opportunities, at scale, via system tools, and for examples, trackable digital objects made available to clients, which serve to provide centralized and attributable data triggers throughout the clients' properties, permitting multichannel attribution, around, for example, a standardized set of metrics, marketing intelligence and behavioral data provided by the system.

Conventionally, attribution businesses almost universally deliver solutions to their clients that are, in general terms, aimed at evaluating and refining multiple advertising and marketing methods so that they can be more targeted and deliver a more accurate ROI measurement. The focus of these businesses is usually on delivering enterprise-driven advertising messages via multiple means.

According to one aspect, the system provides significant advantages over conventional attribution marketing because the system does not attempt to deliver more targeted advertising—rather the system facilitates and generates individual calls to action (e.g., actual transactions) based on an individual's behavior, and incentivizes the sharing of those, and other, calls to action into individuals' social media networks.

According to some embodiments, the system gathers and records not just the actions of individuals but the relative value between people, the products they interact with and their digital communities, which can be based on standardized values and data, Relative value can be measured by reference to direct transactions (e.g., sales) that result from a share/recommendation from one individual to another. In one example, by measuring relative value between individuals, clients can manage and reward their most valuable customers, and their influence, in their communities. Likewise, enterprise clients can also measure the success or failure of their marketing, and the products being marketed via sharing, including associated demand through clicks and sales, recording and leveraging the entire user and journey and product engagement.

The system is highly configurable in that the user can identify any action associated with a share and track it through to the meaningful action that happens on a site (e.g., on or off site). The action can include making a transaction, signing-up to a newsletter, and could even be booking a test drive. From the perspective of the system, it is irrelevant as to whether the client is a struggling musician or an insurance broker, the system tracks events agnostically, without regard to the type or nature of the event. The system can be configured to analyze the quality of user behavior/interaction and not just the quantity. For example, the system can measure sales generated per advocate. The system can report whether an advocate's recommendation is worth 5 p or £50, measured by reference to the monetary value of sales resulting from a that advocates activity or recommendation.

In various embodiments, the system can be unique in the way that the technology is delivered and facilitated; comprising both a client/end user-orientated self-serve platform, and a developer/super-user driven portal comprising of advanced debug tools. This approach reduces the barrier to entry for both the low level technologist and high-end developer, providing the fastest possible routes to campaign creation, data aggregation and deployment in a robust highly configurable and testable environment. Various embodiments of the system overcome some of the limitation of conventional approaches. In one example, companies who reward advocates and influencers of so on the basis of either how many times that individual shares or by the traffic they drive to a site. As a result, the only information that those companies have to qualify influence isn't based on the quality of a recommendation, or the advocate's influence, but the quantity.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for awarding user activity among a plurality of users, the system comprising:
at least one processor operatively connected to a memory, the at least one processor when running is configured to execute a plurality of system components;
a distribution component configured to share a digital object with a plurality of users responsive to selection of at least one of a plurality of selectable communication channels, wherein the digital object includes attribution information for an originating user;
a tracking component configured to track interactions with the digital object by the plurality of users;
an attribution component configured to attribute the tracked interactions to a campaign created by the originating user;
an award-determining component configured to determine an award responsive to an attribution determination performed by the attribution component.

2. The system according to claim 1, further comprising a valuation component configured to establish a value associated with the originating user's influence over the plurality of users.

3. The system according to claim 2, wherein the valuation component is further configured to determine a value associated with the originating user's influence with respective ones of the plurality of selectable communication channels.

4. The system according to claim 1, further comprising a user interface component configured to present user interfaces for designing a campaign.

5. The system according to claim 4, wherein the system is configured to accept registration information from the plurality of users, and wherein the distribution component is further configured to distribute the digital object including attribution information for respective ones of the plurality of users, responsive to accepting respective registration information.

6. The system according to claim 4, wherein the user interface component is further configured to present user interfaces for defining award criteria associated with the campaign.

7. The system according to claim 6, wherein the user interface component is further configured to present user interfaces for defining one or more actions associated with the digital object to be tracked or attributed.

8. The system according to claim 7, wherein the tracking component is configured to receive information on the one or more user actions responsive to user selection of an action element in the digital object.

9. The system according to claim 1, the system further comprises a generation component configured to create a uniquely addressable web presence associated with the digital object.

10. The system according to claim 9, wherein the tracking component is configured to receive information on the one or more user actions responsive to user selection of an action element associated with the uniquely addressable web presence.

11. The system according to claim 1, wherein the award-determining component is further configured to determine an award responsive to a plurality of user defined awards defined by the originating user.

12. The system according to claim 11, wherein the award-determining component is further configured to determine completion of any one or more of the plurality of the user defined awards responsive to comparing the tracked interactions attributed to a respective one of the plurality of users to a threshold associated with one or more desired user actions.

13. The system according to claim 12, wherein the desired action includes at least one of a group comprising a view of the digital object, a sharing of the digital object with at least one other user, a transaction relating to the digital object, a view of a uniquely addressable web presence associated with the digital object, an action taken within a uniquely addressable web presence associated with the digital object, a transaction, an online action relating to the digital object, and an offline action associated with the digital object.

14. The system according to claim 1, wherein the tracking component is further configured to:
receive information on receipt by a plurality of recipient users of the digital object;
identify unique recipient users of the digital object; and
collect information regarding the unique recipient users of the received object.

15. A computer implemented method for awarding user activity among a plurality of users, the method comprising:
distributing, by a computer system, a digital object to a plurality of users responsive to selection of at least one of a plurality of selectable communication channels, wherein the digital object includes attribution information for an originating user;
tracking, by the computer system, interactions with the digital object by the plurality of users;
attributing, by the computer system, the tracked interactions to a campaign created by an originating user;
determining, by the computer system, an award responsive to the act of attributing performed by the computer system.

16. The method according to claim 15, further comprising a user interface component configured to present user interfaces for designing a campaign.

17. The method according to claim 16, further comprising receiving, by the computer system, registration information from the plurality of users, and wherein the act of distributing the digital object includes distributing the digital object with attribution information for respective ones of the plurality of users, responsive to receiving respective registration information.

18. The method according to claim 16, further comprising displaying user interfaces for defining award criteria associated with the campaign.

19. The method according to claim 18, further comprising displaying user interfaces for defining one or more actions associated with the digital object to be tracked or attributed.

20. The method according to claim 19, wherein the act of tracking includes receiving information on the one or more user actions responsive to user selection of an action element in the digital object.

21. The method according to claim 15, the method further comprises generating, by the computer system. a uniquely addressable web presence associated with the digital object.

22. The method according to claim 21, wherein the act of tracking includes receiving information on the one or more user actions responsive to user selection of an action element associated with the uniquely addressable web presence.

23. The method according to claim 15, wherein the act of determining the award includes determining an award responsive to a plurality of a user defined awards.

24. The method according to claim 23, wherein the act of determining the award includes determining completion of any one or more of the plurality of the user defined awards responsive to comparing the tracked interactions attributed to a respective one of the plurality of users to a threshold associated with one or more desired user actions.

25. The method according to claim 24, wherein the desired action includes at least one of a group comprising a view of the digital object, a sharing of the digital object with at least one other user, a transaction relating to the digital object, a view of a uniquely addressable web presence associated with the digital object, an action taken within a uniquely addressable web presence associated with the digital object, a transaction, an online action relating to the digital object, and an offline action associated with the digital object.

26. The method according to claim 15, wherein the method further comprises:
receiving information on receipt by a plurality of recipient users of the digital object;
identifying unique recipient users of the digital object; and
collecting information regarding the unique recipient users of the received object.
